(19) United States
(12) Patent Application Publication
(10) Pub. No.: US 2024/0260631 A1
(43) Pub. Date: Aug. 8, 2024

(54) ACETIC ACID-CONTAINING COMPOSITION

(71) Applicant: Mizkan Holdings Co., Ltd., Aichi (JP)

(72) Inventors: Mizuki Yasui, Aichi (JP); Chika Ichinose, Aichi (JP)

(73) Assignee: Mizkan Holdings Co., Ltd., Aichi (JP)

(21) Appl. No.: 18/417,990

(22) Filed: Jan. 19, 2024

Related U.S. Application Data
(63) Continuation-in-part of application No. PCT/JP2022/028309, filed on Jul. 21, 2022.

(30) Foreign Application Priority Data
Jul. 21, 2021 (JP) 2021-120742

(51) Int. Cl. A23L 27/00; A23F 3/34; A23F 3/40; A23L 27/20; A23L 33/21; C11D 1/72; C11D 3/20

(52) U.S. Cl. CPC A23L 27/84; A23F 3/34; A23F 3/405; A23L 27/2028; A23L 27/2052; A23L 33/21; C11D 1/72; C11D 3/2072; C11D 3/2079; C11D 3/2096

(57) ABSTRACT

The acetic acid-containing composition contains acetic acid and one or more components selected from (A) 2-octenal, (B) (+)-rose oxide, and (C) 1,8-cineole. The acetic acid odor of an acetic acid-containing composition, such as a food or beverage product or a cleaner containing acetic acid is suppressed. A method for producing an acetic acid-containing composition includes a step of adding one or more components selected from (A) 2-octenal, (B) (+)-rose oxide, and (C) 1,8-cineole to an acetic acid-containing composition. A method for suppressing the acetic acid odor of an acetic acid-containing composition is also provided.

### TECHNICAL FIELD

One or more embodiments of the present invention relate to an acetic acid-containing composition, such as a food or beverage product or a cleaner containing acetic acid with the suppressed acetic acid odor.

### BACKGROUND

Vinegar comprising, as a main ingredient, acetic acid is a basic seasoning used for cooking various food materials. Also, vinegar is blended together with other ingredients into various food or beverage products, such as a vinegar beverage and ponzu soy sauce, and it is an essential raw material for producing food or beverage products. As health consciousness increases in recent years, a wide variety of food or beverage products and supplements made from vinegar have drawn attention in hope of useful activity of acetic acid for health, such as reduction of visceral fat, lowering of blood pressure, and inhibition of postprandial elevation of blood glucose levels.

Because of its acidic property, acetic acid is capable of eliminating alkaline stains, such as water scale or soap scum, and alkaline odor, such as ammonia odor. Thus, acetic acid is used for cleaners for water areas, such as the kitchen and the bathroom. In addition, acetic acid has excellent bacteriostatic and antiseptic effects. Thus, acetic acid has heretofore been known to inhibit deterioration in a food or beverage product and effectively prevent food poisoning. From the viewpoint of antibacterial and antifungal effects, acetic acid has been extensively used in the fields of public health and environmental technology.

However, acetic acid has a distinctive pungent odor. This imposes a limitation in the amount of use thereof for cooking or leaves acetic acid odor during or after cleaning, disadvantageously. In order to dissolve the above, suppression of the acetic acid odor of acetic acid-containing products has been attempted. For example, Patent Literature 1 discloses an agent for masking the acetic acid odor of an acetic acid-containing product containing at least one compound selected from the group consisting of linalool oxide, benzyl alcohol, ethyl pyruvate, isobutyl alcohol, maltol isobutyrate, and neohesperidin dihydrochalcone. Patent Literature 2 discloses an acetic acid-containing food and drink containing given amounts of camphor and/or eugenol relative to acetic acid. Patent Literature 3 discloses an acetic acid odor depressant, which is blended in an acetic acid cleaner composition containing, as an active ingredient, acetic acid and consists of one or more kinds of alkyl glycosides and an acetic acid cleaner composition comprising the same. According to conventional techniques, effects of acetic acid odor suppression may not be sufficient, and a taste or flavor inherent to the food or beverage product may be deteriorated or altered. If an ingredient with higher effects of acetic acid odor suppression is found, the utility value of acetic acid can further be enhanced, and the market for acetic acid-containing products can be expanded.

### PATENT LITERATURE

Patent Literature 1: JP 2020-124142 A
Patent Literature 2: JP 2011-217655 A
Patent Literature 3: JP 2019-104838 A

### SUMMARY

One or more embodiments of the present invention are intended to suppress acetic acid odor of an acetic acid-containing composition, such as a food or beverage product or a cleaner containing acetic acid.

The present inventors have conducted concentrated studies in order to resolve the above. As a result, they discovered that acetic acid odor of an acetic acid-containing composition would be selectively suppressed (masked) by blending one or more components selected from the group consisting of (A) 2-octenal, (B) (+)-rose oxide, and (C) 1,8-cineole in an acetic acid-containing composition. This has led to the completion of one or more embodiments of the present invention.

Specifically, one or more embodiments of the present invention include the following inventions.

(1) An acetic acid-containing composition comprising, acetic acid at 0.02 w/v % or more and one or more components selected from the group consisting of (A) 2-octenal, (B) (+)-rose oxide, and (C) 1,8-cineole.
(2) The acetic acid-containing composition according to (1), wherein the content of the acetic acid is 0.02 w/v % or more, 0.03 w/v % or more, 0.04 w/v % or more, 0.08 w/v % or more, 0.1 w/v % or more, 0.15 w/v % or more, 0.2 w/v % or more, 0.25 w/v % or more, 0.3 w/v % or more, 0.5 w/v % or more, 1.0 w/v % or more, 2.0 w/v % or more, 3.0 w/v % or more, 4.0 w/v % or more, 5.0 w/v % or more, 6.0 w/v % or more, 8.0 w/v % or more, or more than 10.0 w/v %, and is 40 w/v % or less, 30 w/v % or less, 25 w/v % or less, 20 w/v % or less, or 15 w/v % or less.
(3) The acetic acid-containing composition according to (1) or (2), wherein the concentration of undissociated acetic acid (AH) in the acetic acid-containing composition is 10 w/v % or more, 12 w/v % or more, 14 w/v % or more, 16 w/v % or more, 18 w/v % or more, or 20 w/v % or more, and is 40 w/v % or less, 35 w/v % or less, 30 w/v % or less, or 25 w/v % or less.
(4) The acetic acid-containing composition according to any of (1) to (3), wherein a pH level of the acetic acid-containing composition is 1.0 or higher, 2.0 or higher, 2.1 or higher, 2.2 or higher, 2.3 or higher, 2.4 or higher, 2.5 or higher, 2.6 or higher, 2.7 or higher, 2.8 or higher, 2.9 or higher, 3.0 or higher, 3.2 or higher, 3.4 or higher, 3.6 or higher, or 3.8 or higher, and is less than 7.0, less than 6.5, less than 6.0, less than 5.5, less than 5.0, less than 4.6, or less than 4.0.
(5) The acetic acid-containing composition according to any of (1) to (4), wherein the content of (A) 2-octenal in the acetic acid-containing composition is 0.001 ppb or more, 0.01 ppb or more, 0.1 ppb or more, 1.0 ppb or more, 5.0 ppb or more, 10 ppb or more, 20 ppb or more, 50 ppb or more, 100 ppb or more, 200 ppb or more, or 300 ppb or more, and is 1000 ppb or less, 900 ppb or less, 800 ppb or less, 700 ppb or less, or 600 ppb or less.
(6) The acetic acid-containing composition according to any of (1) to (5), wherein the content of (B) (+)-rose oxide in the acetic acid-containing composition is 0.001 ppb or more, 0.01 ppb or more, 0.1 ppb or more, 1.0 ppb or more, 5.0 ppb or more, 10 ppb or more, 20 ppb or more, 50 ppb or more, 100 ppb or more, 200 ppb or more, or 300 ppb or more, and is 1000 ppb or less, 900 ppb or less, 800 ppb or less, 700 ppb or less, or 600 ppb or less.
(7) The acetic acid-containing composition according to any of (1) to (6), wherein the content of (C) 1,8-cineole in the acetic acid-containing composition is 0.001 ppb or more, 0.01 ppb or more, 0.1 ppb or more, 1.0 ppb or more, 5.0 ppb or more, 10 ppb or more, 20 ppb or more, 50 ppb or more, 100 ppb or more, 200 ppb or more, or 300 ppb or more, and is 1000 ppb or less, 900 ppb or less, 800 ppb or less, 700 ppb or less, or 600 ppb or less.
(8) The acetic acid-containing composition according to any of (1) to (7), wherein a ratio of the content of (A) 2-octenal to the content of acetic acid (2-octenal (ppb)/acetic acid (w/v %)) is 0.0005 or more, 0.0007 or more, 0.001 or more, 0.002 or more, 0.02 or more, 0.2 or more, 2.0 or more, 4.0 or more, 6.0 or more, 8.0 or more, 10 or more, 15 or more, 20 or more, 30 or more, 50 or more, 60 or more, 70 or more, or 80 or more, and is 500 or less, 400 or less, 300 or less, 200 or less, or 100 or less.
(9) The acetic acid-containing composition according to any of (1) to (8), wherein a ratio of the content of (B) (+)-rose oxide to the content of acetic acid ((+)-rose oxide (ppb)/acetic acid (w/v %)) is 0.0005 or more, 0.0007 or more, 0.001 or more, 0.002 or more, 0.02 or more, 0.2 or more, 2.0 or more, 4.0 or more, 6.0 or more, 8.0 or more, 10 or more, 15 or more, 20 or more, 30 or more, 50 or more, 60 or more, 70 or more, or 80 or more, and is 500 or less, 400 or less, 300 or less, 200 or less, or 100 or less.
(10) The acetic acid-containing composition according to any of (1) to (9), wherein a ratio of the content of (C) 1,8-cineole to the content of acetic acid ((C) 1,8-cineole (ppb)/acetic acid (w/v %)) is 0.0005 or more, 0.0007 or more, 0.001 or more, 0.002 or more, 0.02 or more, 0.2 or more, 2.0 or more, 4.0 or more, 6.0 or more, 8.0 or more, 10 or more, 15 or more, 20 or more, 30 or more, 50 or more, 60 or more, 70 or more, or 80 or more, and is 500 or less, 400 or less, 300 or less, 200 or less, or 100 or less.
(11) The acetic acid-containing composition according to any of (1) to (10), wherein the content of (B) (+)-rose oxide relative to 1 part by mass of (A) 2-octenal is 0.00001 parts by mass or more, 0.0001 parts by mass or more, 0.001 parts by mass or more, 0.01 parts by mass or more, or 0.1 parts by mass or more, and is 100000 parts by mass or less, 10000 parts by mass or less, 1000 parts by mass or less, 100 parts by mass or less, 10 parts by mass or less, or 1 part by mass or less.
(12) The acetic acid-containing composition according to any of (1) to (11), wherein the content of (C) 1,8-cineole relative to 1 part by mass of (A) 2-octenal is 0.00001 parts by mass or more, 0.0001 parts by mass or more, 0.001 parts by mass or more, 0.01 parts by mass or more, or 0.1 parts by mass or more, and is 100000 parts by mass or less, 10000 parts by mass or less, 1000 parts by mass or less, 100 parts by mass or less, 10 parts by mass or less, or 1 part by mass or less.
(13) The acetic acid-containing composition according to any of (1) to (12), wherein the content of (C) 1,8-cineole relative to 1 part by mass of (B) (+)-rose oxide is 0.00001 parts by mass or more, 0.0001 parts by mass or more, 0.001 parts by mass or more, 0.01 parts by mass or more, or 0.1 parts by mass or more, and is 100000 parts by mass or less, 10000 parts by mass or less, 1000 parts by mass or less, 100 parts by mass or less, 10 parts by mass or less, or 1 part by mass or less.
(14) The acetic acid-containing composition according to any of (1) to (13), wherein the total amount of (A) 2-octenal and (B) (+)-rose oxide relative to 1 part by mass of (C) 1,8-cineole is 0.000005 parts by mass or more, 0.0005 parts by mass or more, 0.005 parts by mass or more, or 0.05 parts by mass or more, and is 200000 parts by mass or less, 20000 parts by mass or less, 2000 parts by mass or less, or 200 parts by mass or less.
(15) The acetic acid-containing composition according to any of (1) to (14), wherein one or more components selected from the group consisting of (A) 2-octenal, (B) (+)-rose oxide, and (C) 1,8-cineole are derived from an extract of plant material.
(16) The acetic acid-containing composition according to (15), wherein the plant material is at least one member selected from among grape, apricot, melon, water melon, mango, kiwi fruit, rosemary, olive, elderflower, rose, geranium, lemongrass, yellow batai, eucalyptus, peppermint, fenugreek, chamomile, cardamom, cumin, apple mint, laurel, cinnamon, rosehip, thyme, and nutmeg.
(17) The acetic acid-containing composition according to (15) or (16), wherein the plant material is a plant in a dry state.
(18) The acetic acid-containing composition according to (15), wherein the extract of plant material is obtained with the use of an edible solvent.
(19) The acetic acid-containing composition according to (18), wherein the edible solvent is at least one member selected from among water, ethanol, ethyl acetate, acetic acid, propanol, and hexane.
(20) The acetic acid-containing composition according to any of (1) to (19), wherein the acetic acid-containing composition is a food or beverage product or a non-food or beverage product.
(21) The acetic acid-containing composition according to any of (1) to (20), wherein the acetic acid-containing composition is a cleaner composition, which further contains a surfactant, according to need.
(22) A method for producing the acetic acid-containing composition according to any of (1) to (21), which comprises the following steps (i) and (ii):
(i) a step of preparing an acetic acid-containing composition containing acetic acid at 0.02 w/v % or higher; and
(ii) a step of adding one or more components selected from the group consisting of (A) 2-octenal, (B) (+)-rose oxide, and (C) 1,8-cineole to the acetic acid-containing composition obtained in the step (i).
   (23) The method for producing an acetic acid-containing composition according to (22), wherein, in the step (i), the content of acetic acid in the acetic acid-containing composition is 0.02 w/v % or more, 0.03 w/v % or more, 0.04 w/v % or more, 0.08 w/v % or more, 0.1 w/v % or more, 0.15 w/v % or more, 0.2 w/v % or more, 0.25 w/v % or more, 0.3 w/v % or more, 0.5 w/v % or more, 1.0 w/v % or more, 2.0 w/v % or more, 3.0 w/v % or more, 4.0 w/v % or more, 5.0 w/v % or more, 6.0 w/v % or more, 8.0 w/v % or more, or more than 10.0 w/v %, and is 40 w/v % or less, 30 w/v % or less, 25 w/v % or less, 20 w/v % or less, or 15 w/v % or less.
   (24) The method for producing an acetic acid-containing composition according to (23), wherein, in the step (i), the concentration of undissociated acetic acid (AH) in the acetic acid-containing composition is 10 w/v % or more, 12 w/v % or more, 14 w/v % or more, 16 w/v % or more, 18 w/v % or more, or 20 w/v % or more, and is 40 w/v % or less, 35 w/v % or less, 30 w/v % or less, or 25 w/v % or less.
   (25) The method for producing an acetic acid-containing composition according to any of (22) to (24), wherein the step (ii) comprises adding (A) 2-octenal to an acetic acid-containing composition, so as to adjust the concentration of the (A) 2-octenal in the acetic acid-containing composition to 0.001 ppb or more, 0.01 ppb or more, 0.1 ppb or more, 1.0 ppb or more, 5.0 ppb or more, 10 ppb or more, 20 ppb or more, 50 ppb or more, 100 ppb or more, 200 ppb or more, or 300 ppb or more, and is 1000 ppb or less, 900 ppb or less, 800 ppb or less, 700 ppb or less, or 600 ppb or less.
   (26) The method for producing an acetic acid-containing composition according to any of (22) to (25), wherein the step (ii) comprises adding (B) (+)-rose oxide to an acetic acid-containing composition, so as to adjust the concentration of the (B) (+)-rose oxide in the acetic acid-containing composition to 0.001 ppb or more, 0.01 ppb or more, 0.1 ppb or more, 1.0 ppb or more, 5.0 ppb or more, 10 ppb or more, 20 ppb or more, 50 ppb or more, 100 ppb or more, 200 ppb or more, or 300 ppb or more, and is 1000 ppb or less, 900 ppb or less, 800 ppb or less, 700 ppb or less, or 600 ppb or less.
   (27) The method for producing an acetic acid-containing composition according to any of (22) to (26), wherein the step (ii) comprises adding (C) 1,8-cineole to an acetic acid-containing composition, so as to adjust the concentration of the (C) 1,8-cineole in the acetic acid-containing composition to 0.001 ppb or more, 0.01 ppb or more, 0.1 ppb or more, 1.0 ppb or more, 5.0 ppb or more, 10 ppb or more, 20 ppb or more, 50 ppb or more, 100 ppb or more, 200 ppb or more, or 300 ppb or more, and is 1000 ppb or less, 900 ppb or less, 800 ppb or less, 700 ppb or less, or 600 ppb or less.
   (28) The method for producing an acetic acid-containing composition according to any of (22) to (27), wherein the step (ii) further comprises a step of extracting a plant material.
   (29) The method for producing an acetic acid-containing composition according to (28), wherein the plant material is at least one member selected from among grape, apricot, melon, water melon, mango, kiwi fruit, rosemary, olive, elderflower, rose, geranium, lemongrass, yellow batai, eucalyptus, peppermint, fenugreek, chamomile, cardamom, cumin, apple mint, laurel, cinnamon, rosehip, thyme, and nutmeg.
   (30) The method for producing an acetic acid-containing composition according to (28) or (29), wherein the plant material is a plant in a dry state.
   (31) The method for producing an acetic acid-containing composition according to (28), wherein the extract of plant material is obtained with the use of an edible solvent.
   (32) The method for producing an acetic acid-containing composition according to (31), wherein the edible solvent is at least one member selected from among water, ethanol, ethyl acetate, acetic acid, propanol, and hexane.
   (33) The method for producing an acetic acid-containing composition according to any of (28) to (32), wherein a pH level of the extraction solvent used in the step (ii) of extracting a plant material is 1.0 or higher, 2.0 or higher, 2.1 or higher, 2.2 or higher, 2.3 or higher, 2.4 or higher, 2.5 or higher, 2.6 or higher, 2.7 or higher, 2.8 or higher, 2.9 or higher, 3.0 or higher, 3.2 or higher, 3.4 or higher, 3.6 or higher, or 3.8 or higher, and is less than 8.0, less than 7.5, less than 7.0, less than 6.5, less than 6.0, less than 5.5, less than 5.0, less than 4.6, or less than 4.0.
   (34) The method for producing an acetic acid-containing composition according to any of (28) to (33), wherein temperature for heating the extraction solvent used in the step (ii) of extracting a plant material is 20° C. or higher, 25° C. or higher, 30° C. or higher, 40° C. or higher, 50° C. or higher, 55° C. or higher, 60° C. or higher, 65° C. or higher, 70° C. or higher, 75° C. or higher, 80° C. or higher, 85° C. or higher, 90° C. or higher, or 95° C. or higher, and is 105° C. or lower or 100° C. or lower and a period of heating is 30 seconds or longer, 1 minute or longer, 2 minutes or longer, or 3 minutes or longer, and is less than 1500 minutes, less than 1200 minutes, less than 1000 minutes, less than 600 minutes, less than 300 minutes, less than 180 minutes, less than 60 minutes, less than 30 minutes, less than 25 minutes, less than 20 minutes, less than 15 minutes, less than 10 minutes, or less than 5 minutes.
   (35) The method for producing an acetic acid-containing composition according to any of (22) to (34), wherein the content of dietary fiber in the acetic acid-containing composition in the step (ii) is 10% by mass or less, 9% by mass or less, 8% by mass or less, 7% by mass or less, 6% by mass or less, or 5% by mass or less, and is more than 0% by mass, 1% by mass or more, 2% by mass or more, 3% by mass or more, or 4% by mass or more than the content of dietary fiber in the acetic acid-containing composition in the step (i).
   (36) The method for producing an acetic acid-containing composition according to any of (22) to (35), wherein a difference in haze values before and after extraction of an extract of plant material in the step (ii) is 0.3% or more, 0.6% or more, or 1% or more and is 20% or less, 18% or less, or 15% or less.
   (37) The method for producing an acetic acid-containing composition according to any of (22) to (36), wherein the step (i) or (ii) comprises adding a surfactant.
   (38) The method for producing an acetic acid-containing composition according to any of (22) to (37), which further comprise the following step (iii):
(iii) a step of modifying a pH level of the extract of plant material to a relatively acidic level.
   (39) Use of one or more components selected from the group consisting of (A) 2-octenal, (B) (+)-rose oxide, and (C) 1,8-cineole to suppress acetic acid odor.

According to one or more embodiments of the present invention, acetic acid odor of an acetic acid-containing composition, such as a food or beverage product or a cleaner containing acetic acid, can be suppressed. The acetic acid-containing composition of one or more embodiments of the present invention is substantially free of pungent acetic acid odor, and it would not leave acetic acid odor in the air. Accordingly, it is possible to eat or use the acetic acid-containing composition of one or more embodiments of the present invention without a concern of acetic acid odor. Therefore, one or more embodiments of the present invention can improve the applicability of acetic acid with health benefits or antiseptic effects.

The description incorporates the contents disclosed by JP Patent Application No. 2021-120742 filed on Jul. 21, 2022, based on which the priority of the present application claims.

### DETAILED DESCRIPTION

In the present description, when there are a plurality of upper limits and/or a plurality of lower limits for a specified numerical range, it is understood that a numerical range defined by the maximum of the upper limit and the minimum of the lower limit is at least directly described even if it is not clearly stated. All numerical ranges combining any of those upper limits and any of those lower limits are included in one or more embodiments of the present invention. Furthermore, in the present disclosure, the numerical ranges described with “to” therebetween means that the numerical ranges include the values before and after “to” as the lower limit and the upper limit. When a plurality of lower limits and a plurality of upper limits are described separately, any of the lower limits and the upper limits may be selected and connected by “to.”

### 1. Acetic Acid-Containing Composition

The acetic acid-containing composition of one or more embodiments of the present invention comprises acetic acid and one or more components selected from the group consisting of (A) 2-octenal, (B) (+)-rose oxide, and (C) 1,8-cineole. A component selected from among (A) 2-octenal, (B) (+)-rose oxide, and (C) 1,8-cineole may be used by itself. Use of two or more components is preferable from the viewpoint of enhanced effects of acetic acid odor suppression. When two or more components selected from among components (A), (B), and (C) are used, they may be used in any combination without limitation. For example, any of the combinations (A) and (B), (A) and (C), (B) and (C), or (A), (B), and (C) may be used. When two or more components are used in combination, the mixing ratio thereof is not limited.

In the present disclosure, the term “acetic acid odor” refers to pungent odor that originates from acetic acid. The term “odor” encompasses both odor that is directly sensed through the nose and odor that is sensed from the throat to the nasal cavity during swallowing through the mouth. When acetic acid odor is suppressed, the acetic acid odor is made partially or completely insensible.

### (Acetic Acid)

In the present disclosure, the term “acetic acid” refers to an acetic acid molecule (CH₃COOH) and an acetic acid ion (CH₃COO⁻), and the term “the content of acetic acid” refers to a concentration of the total of the acetic acid molecule and the acetic acid ion. The content of acetic acid in the acetic acid-containing composition of one or more embodiments of the present invention is not particularly limited. In order to exert the effects of one or more embodiments of the present invention in the presence of acetic acid, for example, the concentration thereof may be 0.02 w/v % or higher. More specifically, the lower limit of the concentration is 0.02 w/v % or more, 0.03 w/v % or more, 0.04 w/v % or more, 0.08 w/v % or more, 0.1 w/v % or more, 0.15 w/v % or more, 0.2 w/v % or more, 0.25 w/v % or more, 0.3 w/v % or more, 0.5 w/v % or more, 1.0 w/v % or more, 2.0 w/v % or more, 3.0 w/v % or more, 4.0 w/v % or more, 5.0 w/v % or more, 6.0 w/v % or more, 8.0 w/v % or more, or more than 10.0 w/v %, and the upper limit of the concentration is 40 w/v % or less, 30 w/v % or less, 25 w/v % or less, 20 w/v % or less, or 15 w/v % or less. At the content of acetic acid of 40 w/v % or less, satisfactory effects of the components (A) to (C) to suppress acetic acid odor can be achieved. The mass/volume percent (w/v %) is used herein to express the mass of the solute relative to the volume of the whole solution in percent figures. The origin of acetic acid in the acetic acid-containing composition of one or more embodiments of the present invention is not particularly limited. Glacial acetic acid may be used, and various types of vinegar products containing other components, such as vinegar, may be used. When the acetic acid-containing composition of one or more embodiments of the present invention is a food or beverage product, acetic acid suitable for a food or beverage product is preferable. For example, acetic acid may be derived from a food additive, or it may be derived from a seasoning or a food raw material to be blended into a food or beverage product. The content of acetic acid can be measured by high-performance liquid chromatography described below.

### (Concentration of Undissociated Acetic Acid (AH))

A dissociated acetic acid molecule is known to be in resonance with an undissociated acetic acid in an aqueous solution. When the concentration of dissociated acetic acid is designated to be [A⁻], the concentration of proton is designated to be [H⁺], and the concentration of undissociated acetic acid is designated to be [AH], specifically, dissociated acetic acid and undissociated acetic acid are balanced in the state shown in the following formula.

[AH]↔[H⁺]+[A⁻] (Formula 1)

The concentration of dissociated acetic acid [A⁻] can be determined in accordance with the following formula based on pH and acetic acid concentration.

pH=4.76+log₁₀[A⁻]/[AH] (Formula 2)

Proton concentration is known to vary to a significant extent depending on pH levels. The effects of acetic acid to inhibit microbial growth are enhanced at a lower pH level because the extent of acetic acid dissociation varies depending on pH levels. Dissociation is inhibited as a pH level lowers and proton concentration increases. This results in an increased proportion of undissociated molecules. Since undissociated molecules have higher cell permeability than dissociated molecules, microbial growth can be suppressed more efficiently as a pH level lowers.

When the acetic acid-containing composition of one or more embodiments of the present invention is used in the form of a cleaner composition, it is preferable that the concentration of undissociated acetic acid (AH) be modified in the range of 10 w/v % to 40 w/v % in order to achieve bacteriostatic and antiseptic effects. More specifically, the lower limit of the concentration may be 10 w/v % or more, 12 w/v % or more, 14 w/v % or more, 16 w/v % or more, 18 w/v % or more, or 20 w/v % or more, and the upper limit thereof may be 40 w/v % or less, 35 w/v % or less, 30 w/v % or less, or 25 w/v % or less.

It is preferable that a pH level of the acetic acid-containing composition of one or more embodiments of the present invention be modified in the range of 1.0 to 7.0 from the viewpoint of the flavor-taste balance and the concentration of the undissociated acetic acid. More specifically, the lower limit of the pH level of the acetic acid-containing composition can be 1.0 or higher, 2.0 or higher, 2.1 or higher, 2.2 or higher, 2.3 or higher, 2.4 or higher, 2.5 or higher, 2.6 or higher, 2.7 or higher, 2.8 or higher, 2.9 or higher, 3.0 or higher, 3.2 or higher, 3.4 or higher, 3.6 or higher, or 3.8 or higher, while the upper limit thereof is less than 7.0, less than 6.5, less than 6.0, less than 5.5, less than 5.0, less than 4.6, or less than 4.0. In the case of an acetic acid-containing composition with the acetic acid concentration of 1 w/v % or higher, in particular, the lower limit of the pH level may be 1.0 or higher, 2.0 or higher, 2.1 or higher, 2.2 or higher, 2.3 or higher, 2.4 or higher, or 2.5 or higher, while the upper limit thereof may be less than 4.6, less than 4.0, less than 3.5, or less than 3.0. In the case of an acetic acid-containing composition with the acetic acid concentration of less than 1 w/v %, the lower limit of the pH level may be 1.0 or higher, 2.0 or higher, 2.1 or higher, 2.2 or higher, 2.3 or higher, 2.4 or higher, 2.5 or higher, 2.6 or higher, 2.7 or higher, or 2.8 or higher, while the upper limit thereof may be less than 7.0, less than 6.0, less than 5.0, less than 4.6, or less than 4.0.

### ((a) 2-Octenal)

2-Octenal (trans-2-octenal) (systematic name: 2-octen-1-al) is an aldehyde represented by a molecular formula C₈H₁₄O (molecular weight: 126.20), and the CAS registry number thereof is 2548-87-0. In the present disclosure, the term “2-octenal” refers to trans-2-octenal, although it is simply denoted as “2-octenal.”

In one or more embodiments of the present invention, the origin of 2-octenal is not particularly limited. For example, it may be derived from a preparation, such as a flavor to be added, or a seasoning or food raw material to be blended in a food or beverage product. When 2-octenal is derived from a food raw material or the like, an extract of plant material containing 2-octenal is preferable. Examples of plant materials containing 2-octenal include grape, apricot, melon, water melon, mango, kiwi fruit, and herbs, such as rosemary, olive, and elderflower. One of such plant materials may be used by itself, or two or more thereof may be used in combination. The plant materials may be used in any state, such as a fresh, dried, or freeze-dried state. From the viewpoint of extraction efficiency, a raw material may be a dried plant material. Examples of drying techniques include, but are not particularly limited to, hot air drying, freeze drying, vacuum drying, spray drying, and drum drying. Extraction is to separate a component that is soluble in a solvent contained in a raw material with the use of a solvent. The plant material containing 2-octenal is added to a solvent, the mixture is allowed to stand, and the resultant is then filtered. Thus, a 2-octenal extract can be prepared. Alternatively, the solvent supplemented with the plant material containing 2-octenal is heated to a given temperature, and the resultant is allowed to stand or held at constant temperature with stirring. Thus, the extract of interest can be prepared. Any solvent suitable for use in food can be used for extraction without particular limitation. Examples thereof include water, ethanol, ethyl acetate, acetic acid, propanol, and hexane, and any thereof may be used by itself or in combination of two or more. In particular, the total content of a hydrophilic solvent may be 50% by mass or more, 70% by mass or more, 90% by mass or more, or 100% by mass. More specifically, the total content of water, ethanol, and acetic acid may be 50% by mass or more, 70% by mass or more, 90% by mass or more, or 100% by mass.

From the viewpoint of extraction efficiency, a pH level of an extraction solvent is from acidic to neutral levels. Specifically, a pH level may be 1.0 or higher, 2.0 or higher, 2.1 or higher, 2.2 or higher, 2.3 or higher, 2.4 or higher, 2.5 or higher, 2.6 or higher, 2.7 or higher, 2.8 or higher, 2.9 or higher, 3.0 or higher, 3.2 or higher, 3.4 or higher, 3.6 or higher, or 3.8 or higher, while the upper limit may be less than 8.0, less than 7.5, less than 7.0, less than 6.5, less than 6.0, less than 5.5, less than 5.0, less than 4.6, or less than 4.0. When it is impossible to measure a pH level because, for example, an extraction solvent does not contain water, a pH level of an extraction solvent can be 7.0.

In one or more embodiments of the present invention, a pH level of an extraction solvent may be modified by adding a plant material containing (A) 2-octenal to an extraction solvent and then modifying a pH level of the extraction solvent. Alternatively, a plant material containing (A) 2-octenal may be added to the extraction solvent with a pH previously modified within a given range. A pH level can be modified by dissolving a pH modifier (e.g., sodium hydroxide, potassium hydroxide, potassium carbonate, calcium carbonate, potassium gluconate, lactic acid, citric acid, tartaric acid, malic acid, or acetic acid) in an extraction solvent.

A solvent used for extraction may be heated, according to need. While heating conditions are not particularly limited, for example, heating temperature can be in a range of 20° C. to 105° C., and a heating period can be in a range of 30 seconds or longer and less than 30 minutes. More specifically, the lower limit of the heating temperature is, for example, 20° C. or higher, 25° C. or higher, 30° C. or higher, 40° C. or higher, 50° C. or higher, 55° C. or higher, 60° C. or higher, 65° C. or higher, 70° C. or higher, 75° C. or higher, 80° C. or higher, 85° C. or higher, 90° C. or higher, or 95° C. or higher, while the upper limit thereof is, in general, 105° C. or lower or 100° C. or lower. The lower limit of the heating period is, for example, 30 seconds or longer, 1 minute or longer, 2 minutes or longer, or 3 minutes or longer, while the upper limit thereof is, for example, less than 1500 minutes, less than 1200 minutes, less than 1000 minutes, less than 600 minutes, less than 300 minutes, less than 180 minutes, less than 60 minutes, less than 30 minutes, less than 25 minutes, less than 20 minutes, less than 15 minutes, less than 10 minutes, or less than 5 minutes. In general, there is an approximately co-dependent relationship between a heating temperature and a heating period. While the heating period can generally be shorter as the heating temperature is raised, the heating temperature can generally be lower as the heating period is prolonged. From the viewpoint of the relationship between the heating temperature and the heating period, adequate ranges of the heating temperature and of the heating period may be determined. Specifically, extraction with heating may be performed at 70° C. to 105° C. for less than 25 minutes, at 80° C. to 105° C. for less than 20 minutes, or at 85° C. to 105° C. for less than 15 minutes. In order to efficiently extract a target component from a plant material and prevent contamination with other components derived from plant material as much as possible, in the present step, a plant material may be allowed to stand or stirred and it is not necessarily subjected to disruption, such as homogenization.

The amount of the solvent to be used is not particularly limited. For example, such amount may be at least 10 times, or at least 20 times the amount of a plant material containing (A) 2-octenal (dry weight). When extraction is followed by concentration or isolation, such amount may be up to 100 times for the convenience of operation. A 2-octenal extract can be used for the acetic acid-containing composition of one or more embodiments of the present invention without further processing. According to need, the 2-octenal extract may be subjected to concentration, drying treatment, such as hot air drying, vapor drying, freeze drying, or spray drying, separation and purification, or decolorization, and the resulting concentrated or dried product may then be used.

(A) 2-octenal contained in the acetic acid-containing composition of one or more embodiments of the present invention may be a substance that is contained in a food material, such as an edible plant, that serves as a raw material of the acetic acid-containing composition, a substance that is added separately from the food material when producing the composition of one or more embodiments of the present invention, or a substance that is generated when producing the composition of one or more embodiments of the present invention. Alternatively, the total of (A) 2-octenal derived from two or more thereof may satisfy the given content and/or proportion described above. When (A) 2-octenal is added externally at the time of production of the composition of one or more embodiments of the present invention, a reagent of highly-purified (A) 2-octenal extract may be added, or a processed plant material containing (A) 2-octenal (e.g., an extract) may be added. More than a half (more preferably the whole) of (A) 2-octenal to be contained in the composition may be derived from a food material, or from an edible plant. More specifically, (A) 2-octenal may be derived from one or more members selected from among grape, apricot, melon, water melon, mango, kiwi fruit, rosemary, olive, elderflower, rose, geranium, lemongrass, yellow batai, eucalyptus, peppermint, fenugreek, chamomile, cardamom, cumin, apple mint, laurel, cinnamon, rosehip, thyme, and nutmeg, with elderflower or cardamom being more preferable. The term “processed plant material” used herein refers to a treated product of a plant material containing (A) 2-octenal by means of, for example, drying, grinding, extraction, or purification.

When the acetic acid-containing composition of one or more embodiments of the present invention contains (A) 2-octenal, the content of the component (A) in the acetic acid-containing composition may be, for example, 0.001 ppb to 1000 ppb, so as to suppress the acetic acid odor by itself or in combination with other 2 components. More specifically, the lower limit of the content may be 0.1 ppb or more, 1 ppb or more, or 10 ppb or more. While the upper limit thereof may be 1000 ppb or less, 500 ppb or less, or 100 ppb or less. When the content of the component (A) is less than 0.001 ppb, the acetic acid odor may not be sufficiently suppressed. When the content of the component (A) is more than 1000 ppb, an aromatic odor of the component may adversely affect the acetic acid-containing composition.

A ratio of the content of (A) 2-octenal to the content of acetic acid (2-octenal (ppb)/acetic acid (w/v %)) is set at, for example, 0.0005 to 500. Thus, the effects of one or more embodiments of the present invention may be exerted. More specifically, the lower limit of (2-octenal (ppb)/acetic acid (w/v %)) may be 0.001 or more, 0.01 or more, or 0.1 or more. While the upper limit thereof is not particularly limited, it may be 500 or less, 300 or less, 100 or less, or 50 or less.

### ((B) (+)-Rose Oxide)

(+)-Rose oxide (systematic name: 2-(2-methyl-1-propenyl)-4-methyltetrahydro-2H-pyran) is an ether represented by a molecular formula C₁₀H₁₈O (molecular weight: 154.25), and the CAS registry number thereof is 16409-43-1.

In one or more embodiments of the present invention, the origin of (+)-rose oxide is not particularly limited. For example, it may be derived from a preparation, such as a flavor to be added, or a seasoning or food raw material to be blended in a food or beverage product. When (+)-rose oxide is derived from a food raw material or the like, an extract of plant material containing (+)-rose oxide is preferable. Examples of plant materials containing (+)-rose oxide include essential oils of rose and geranium and herbs, such as rosehip, lemongrass, yellow batai, and elderflower. One of such plant materials may be used by itself, or two or more thereof may be used in combination. The plant materials may be used in any state, such as a fresh, dried, or freeze-dried state. From the viewpoint of extraction efficiency, a raw material may be a dried plant material. Examples of drying techniques include, but are not particularly limited to, hot air drying, freeze drying, vacuum drying, spray drying, and drum drying. Extraction is to separate a component that is soluble in a solvent contained in a raw material with the use of a solvent. The plant material containing (+)-rose oxide is added to a solvent, the mixture is allowed to stand, and the resultant is then filtered. Thus, a (+)-rose oxide extract can be prepared. Alternatively, the solvent supplemented with the plant material containing (+)-rose oxide is heated to a given temperature, and the resultant is allowed to stand or held at constant temperature with stirring. Thus, the extract of interest can be prepared. Any solvent suitable for use in food can be used for extraction without particular limitation. Examples thereof include water, ethanol, ethyl acetate, acetic acid, propanol, and hexane, and any thereof may be used by itself or in combination of two or more. In particular, the total content of a hydrophilic solvent may be 50% by mass or more, 70% by mass or more, 90% by mass or more, or 100% by mass. More specifically, the total content of water, ethanol, and acetic acid may be 50% by mass or more, 70% by mass or more, 90% by mass or more, or 100% by mass.

From the viewpoint of extraction efficiency, a pH level of an extraction solvent is from acidic to neutral levels. Specifically, a pH level may be 1.0 or higher, 2.0 or higher, 2.1 or higher, 2.2 or higher, 2.3 or higher, 2.4 or higher, 2.5 or higher, 2.6 or higher, 2.7 or higher, 2.8 or higher, 2.9 or higher, 3.0 or higher, 3.2 or higher, 3.4 or higher, 3.6 or higher, or 3.8 or higher, while the upper limit may be less than 8.0, less than 7.5, less than 7.0, less than 6.5, less than 6.0, less than 5.5, less than 5.0, less than 4.6, or less than 4.0. In one or more embodiments of the present invention, a pH level of an extraction solvent may be modified by adding a plant material containing (B) (+)-rose oxide to an extraction solvent and then modifying a pH level of the extraction solvent. Alternatively, a plant material containing (B) (+)-rose oxide may be added to the extraction solvent with a pH previously modified within a given range. A pH level can be modified by dissolving a pH modifier (e.g., sodium hydroxide, potassium hydroxide, potassium carbonate, calcium carbonate, potassium gluconate, lactic acid, citric acid, tartaric acid, malic acid, or acetic acid) in an extraction solvent.

A solvent used for extraction may be heated, according to need. While heating conditions are not particularly limited, for example, heating temperature can be in a range of 20° C. to 105° C., and a heating period can be in a range of 30 seconds or longer and less than 30 minutes. More specifically, the lower limit of the heating temperature is, for example, 20° C. or higher, 25° C. or higher, 30° C. or higher, 40° C. or higher, 50° C. or higher, 55° C. or higher, 60° C. or higher, 65° C. or higher, 70° C. or higher, 75° C. or higher, 80° C. or higher, 85° C. or higher, 90° C. or higher, or 95° C. or higher, while the upper limit thereof is, in general, 105° C. or lower or 100° C. or lower. The lower limit of the heating period is, for example, 30 seconds or longer, 1 minute or longer, 2 minutes or longer, or 3 minutes or longer, while the upper limit thereof is, for example, less than 1500 minutes, less than 1200 minutes, less than 1000 minutes, less than 600 minutes, less than 300 minutes, less than 180 minutes, less than 60 minutes, less than 30 minutes, less than 25 minutes, less than 20 minutes, less than 15 minutes, less than 10 minutes, or less than 5 minutes. In general, there is an approximately co-dependent relationship between a heating temperature and a heating period. While the heating period can generally be shorter as the heating temperature is raised, the heating temperature can generally be lower as the heating period is prolonged. From the viewpoint of the relationship between the heating temperature and the heating period, adequate ranges of the heating temperature and of the heating period may be determined. Specifically, extraction with heating may be performed at 70° C. to 105° C. for less than 25 minutes, at 80° C. to 105° C. for less than 20 minutes, or at 85° C. to 105° C. for less than 15 minutes.

The amount of the solvent to be used is not particularly limited. For example, such amount may be at least 10 times, or at least 20 times the amount of a plant material containing (B) (+)-rose oxide (dry weight). When extraction is followed by concentration or isolation, such amount may be up to 100 times for the convenience of operation. A (+)-rose oxide extract can be used for the acetic acid-containing composition of one or more embodiments of the present invention without further processing. According to need, the (+)-rose oxide extract may be subjected to concentration, drying treatment, such as hot air drying, vapor drying, freeze drying, or spray drying, separation and purification, or decolorization, and the resulting concentrated or dried product may then be used.

(B) (+)-rose oxide contained in the acetic acid-containing composition of one or more embodiments of the present invention may be a substance that is contained in a food material such as an edible plant serving as a raw material of the acetic acid-containing composition, a substance that is added separately from the food material when producing the composition of one or more embodiments of the present invention, or a substance that is generated when producing the composition of one or more embodiments of the present invention. Alternatively, the total of (B) (+)-rose oxide derived from two or more thereof may satisfy the given content and/or proportion described above. When (B) (+)-rose oxide is added externally at the time of production of the composition of one or more embodiments of the present invention, a reagent of a highly-purified (B) (+)-rose oxide extract may be added, or a processed plant material containing (B) (+)-rose oxide (e.g., an extract) may be added. More than a half (more preferably the whole) of (B) (+)-rose oxide to be contained in the composition may be derived from a food material, or from an edible plant. More specifically, (B) (+)-rose oxide may be derived from one or more members selected from among grape, apricot, melon, water melon, mango, kiwi fruit, rosemary, olive, elderflower, rose, geranium, lemongrass, yellow batai, eucalyptus, peppermint, fenugreek, chamomile, cardamom, cumin, apple mint, laurel, cinnamon, rosehip, thyme, and nutmeg, with elderflower or cardamom being more preferable. The term “processed plant material” used herein refers to a treated product of a plant material containing (B) (+)-rose oxide by means of, for example, drying, grinding, extraction, or purification.

When the acetic acid-containing composition of one or more embodiments of the present invention contains (B) (+)-rose oxide, the content of the component (B) in the acetic acid-containing composition may be, for example, 0.001 ppb to 1000 ppb, so as to suppress the acetic acid odor by itself or in combination with other 2 components. More specifically, the lower limit of the content may be 0.1 ppb or more, 1 ppb or more, or 10 ppb or more. While the upper limit thereof may be 1000 ppb or less, 500 ppb or less, or 100 ppb or less. When the content of the component (B) is less than 0.001 ppb, the acetic acid odor may not be sufficiently suppressed. When the content of the component (B) is more than 1000 ppb, an aromatic odor of the component may adversely affect the acetic acid-containing composition.

A ratio of the content of (B) (+)-rose oxide to the content of acetic acid ((+)-rose oxide (ppb)/acetic acid (w/v %)) is set at, for example, 0.0005 to 500. Thus, the effects of one or more embodiments of the present invention may be exerted. More specifically, the lower limit of ((+)-rose oxide (ppb)/acetic acid (w/v %)) may be 0.001 or more, 0.01 or more, or 0.1 or more. While the upper limit thereof is not particularly limited, it may be 500 or less, 300 or less, 100 or less, or 50 or less.

### ((C) 1,8-Cineole)

1,8-Cineole (systematic name: 1,3,3-trimethyl-2-oxabicyclo[2.2.2]octane) is a monoterpene cyclic ether represented by a molecular formula C₁₀H₁₈O (molecular weight: 154.25), and the CAS registry number thereof is 470-82-6.

In one or more embodiments of the present invention, the origin of (C) 1,8-cineole is not particularly limited. For example, it may be derived from a preparation, such as a flavor to be added, or a seasoning or food raw material to be blended in a food or beverage product. When 1,8-cineole is derived from a food raw material or the like, an extract of plant material containing 1,8-cineole is preferable. Examples of plant materials containing 1,8-cineole include eucalyptus, peppermint, fenugreek, chamomile, cardamom, cumin, apple mint, laurel, cinnamon, rosemary, thyme, nutmeg, and elderflower. One of such plant materials may be used by itself, or two or more thereof may be used in combination. The plant materials may be used in any state, such as a fresh, dried, or freeze-dried state. From the viewpoint of extraction efficiency, a raw material may be a dried plant material. Examples of drying techniques include, but are not particularly limited to, hot air drying, freeze drying, vacuum drying, spray drying, and drum drying. Extraction is to separate a component that is soluble in a solvent contained in a raw material with the use of a solvent. The plant material containing 1,8-cineole is added to a solvent, the mixture is allowed to stand, and the resultant is then filtered. Thus, a 1,8-cineole extract can be prepared. Alternatively, the solvent supplemented with the plant material containing 1,8-cineole is heated to a given temperature, and the resultant is allowed to stand or held at constant temperature with stirring. Thus, the extract of interest can be prepared. Any solvent suitable for use in food can be used for extraction without particular limitation. Examples thereof include water, ethanol, ethyl acetate, acetic acid, propanol, and hexane, and any thereof may be used by itself or in combination of two or more. The amount of the solvent to be used is not particularly limited. For example, such amount may be at least 10 times, or at least 20 times the amount of the plant material containing 1,8-cineole (dry weight). When extraction is followed by concentration or isolation, such amount may be up to 100 times for the convenience of operation. A 1,8-cineole extract can be used for the acetic acid-containing composition of one or more embodiments of the present invention without further processing. According to need, the 1,8-cineole extract may be subjected to concentration, drying treatment, such as hot air drying, vapor drying, freeze drying, or spray drying, separation and purification, or decolorization, and the resulting concentrated or dried product may then be used.

From the viewpoint of extraction efficiency, a pH level of an extraction solvent is from acidic to neutral levels. Specifically, a pH level may be 1.0 or higher, 2.0 or higher, 2.1 or higher, 2.2 or higher, 2.3 or higher, 2.4 or higher, 2.5 or higher, 2.6 or higher, 2.7 or higher, 2.8 or higher, 2.9 or higher, 3.0 or higher, 3.2 or higher, 3.4 or higher, 3.6 or higher, or 3.8 or higher, while the upper limit may be less than 8.0, less than 7.5, less than 7.0, less than 6.5, less than 6.0, less than 5.5, less than 5.0, less than 4.6, or less than 4.0. In one or more embodiments of the present invention, a pH level of an extraction solvent may be modified by adding a plant material containing (C) 1,8-cineole to an extraction solvent and then modifying a pH level of the extraction solvent. Alternatively, a plant material containing (C) 1,8-cineole may be added to the extraction solvent with a pH previously modified within a given range. A pH level can be modified by dissolving a pH modifier (e.g., sodium hydroxide, potassium hydroxide, potassium carbonate, calcium carbonate, potassium gluconate, lactic acid, citric acid, tartaric acid, malic acid, or acetic acid) in an extraction solvent.

A solvent used for extraction may be heated, according to need. While heating conditions are not particularly limited, for example, heating temperature can be in a range of 20° C. to 105° C., and a heating period can be in a range of 30 seconds or longer and less than 30 minutes. More specifically, the lower limit of the heating temperature is, for example, 20° C. or higher, 25° C. or higher, 30° C. or higher, 40° C. or higher, 50° C. or higher, 55° C. or higher, 60° C. or higher, 65° C. or higher, 70° C. or higher, 75° C. or higher, 80° C. or higher, 85° C. or higher, 90° C. or higher, or 95° C. or higher, while the upper limit thereof is, in general, 105° C. or lower or 100° C. or lower. The lower limit of the heating period is, for example, 30 seconds or longer, 1 minute or longer, 2 minutes or longer, or 3 minutes or longer, while the upper limit thereof is, for example, less than 1500 minutes, less than 1200 minutes, less than 1000 minutes, less than 600 minutes, less than 300 minutes, less than 180 minutes, less than 60 minutes, less than 30 minutes, less than 25 minutes, less than 20 minutes, less than 15 minutes, less than 10 minutes, or less than 5 minutes. In general, there is an approximately co-dependent relationship between a heating temperature and a heating period. While the heating period can generally be shorter as the heating temperature is raised, the heating temperature can generally be lower as the heating period is prolonged. From the viewpoint of the relationship between the heating temperature and the heating period, adequate ranges of the heating temperature and of the heating period may be determined. Specifically, extraction with heating may be performed at 70° C. to 105° C. for less than 25 minutes, at 80° C. to 105° C. for less than 20 minutes, or at 85° C. to 105° C. for less than 15 minutes.

(C) 1,8-cineole contained in the acetic acid-containing composition of one or more embodiments of the present invention may be a substance that is contained in a food material such as an edible plant serving as a raw material of the acetic acid-containing composition, a substance that is added separately from the food material when producing the composition of one or more embodiments of the present invention, or a substance that is generated when producing the composition of one or more embodiments of the present invention. Alternatively, the total of (C) 1,8-cineole derived from two or more thereof may satisfy the given content and/or proportion described above. When (C) 1,8-cineole is added externally at the time of production of the composition of one or more embodiments of the present invention, a reagent of a highly-purified (C) 1,8-cineole extract may be added, or a processed plant material containing (C) 1,8-cineole (e.g., an extract) may be added. More than a half (more preferably the whole) of (C) 1,8-cineole to be contained in the composition may be derived from a food material, or from an edible plant. More specifically, (C) 1,8-cineole may be derived from one or more members selected from among grape, apricot, melon, water melon, mango, kiwi fruit, rosemary, olive, elderflower, rose, geranium, lemongrass, yellow batai, eucalyptus, peppermint, fenugreek, chamomile, cardamom, cumin, apple mint, laurel, cinnamon, rosehip, thyme, and nutmeg, with elderflower or cardamom being more preferable. The term “processed plant material” used herein refers to a treated product of a plant material containing (C) 1,8-cineole by means of, for example, drying, grinding, extraction, or purification.

When the acetic acid-containing composition of one or more embodiments of the present invention contains (C) 1,8-cineole, the content of the component (C) in the acetic acid-containing composition may be, for example, 0.001 ppb to 1000 ppb, so as to suppress the acetic acid odor by itself or in combination with other 2 components. More specifically, the lower limit of the content may be 0.1 ppb or more, 1 ppb or more, or 10 ppb or more. While the upper limit thereof may be 1000 ppb or less, 500 ppb or less, or 100 ppb or less. When the content of the component (C) is less than 0.001 ppb, the acetic acid odor may not be sufficiently suppressed. When the content of the component (C) is more than 1000 ppb, an aromatic odor of the component may adversely affect the acetic acid-containing composition.

A ratio of the content of (C) 1,8-cineole to the content of acetic acid (1,8-cineole (ppb)/acetic acid (w/v %)) is set at, for example, 0.0005 to 500. Thus, the effects of one or more embodiments of the present invention may be exerted. More specifically, the lower limit of the ratio of the content of (C) 1,8-cineole (1,8-cineole (ppb)/acetic acid (w/v %)) may be 0.001 or more, 0.01 or more, or 0.1 or more. While the upper limit is not particularly limited, it may be 500 or less, 300 or less, 100 or less, or 50 or less.

When (A) 2-octenal is used in combination with (B) (+)-rose oxide, the content of (B) (+)-rose oxide relative to 1 part by mass of (A) 2-octenal is set at 0.00001 to 100000 parts by mass. Such content is preferable to synergistically exert the effects of one or more embodiments of the present invention. More specifically, the lower limit of the content of (B) (+)-rose oxide relative to 1 part by mass of (A) 2-octenal may be 0.00001 parts by mass or more, 0.001 parts by mass or more, 0.01 parts by mass or more, or 0.1 parts by mass or more. While the upper limit of the content is not particularly limited, it may be 100000 parts by mass or less, 10000 parts by mass or less, 1000 parts by mass or less, or 100 parts by mass or less.

When (A) 2-octenal is used in combination with (C) 1,8-cineole, the content of (C) 1,8-cineole relative to 1 part by mass of (A) 2-octenal is set at 0.00001 to 100000 parts by mass. Such content is preferable to synergistically exert the effects of one or more embodiments of the present invention. More specifically, the lower limit of the content of (C) 1,8-cineole relative to 1 part by mass of (A) 2-octenal may be 0.00001 parts by mass or more, 0.001 parts by mass or more, 0.01 parts by mass or more, or 0.1 parts by mass or more. While the upper limit of the content is not particularly limited, it may be 100000 parts by mass or less, 10000 parts by mass or less, 1000 parts by mass or less, or 100 parts by mass or less.

When (B) (+)-rose oxide is used in combination with (C) 1,8-cineole, the content of (C) 1,8-cineole relative to 1 part by mass of (B) (+)-rose oxide is set at 0.00001 to 100000 parts by mass. Such content is preferable to synergistically exert the effects of one or more embodiments of the present invention. More specifically, the lower limit of the content of (C) 1,8-cineole relative to 1 part by mass of (B) (+)-rose oxide may be 0.00001 parts by mass or more, 0.001 parts by mass or more, 0.01 parts by mass or more, or 0.1 parts by mass or more. While the upper limit of the content is not particularly limited, it may be 100000 parts by mass or less, 10000 parts by mass or less, 1000 parts by mass or less, or 100 parts by mass or less.

When (A) 2-octenal, (B) (+)-rose oxide, and (C) 1,8-cineole are used in combination, the total amount of (A) 2-octenal and (B) (+)-rose oxide relative to 1 part by mass of (C) 1,8-cineole is set at 0.000005 to 200000 parts by mass. Such amount is preferable to synergistically exert the effects of one or more embodiments of the present invention. More specifically, the lower limit of the total amount of (A) 2-octenal and (B) (+)-rose oxide relative to 1 part by mass of (C) 1,8-cineole may be 0.000005 parts by mass or more, 0.0005 parts by mass or more, 0.005 parts by mass or more, or 0.05 parts by mass or more. While the upper limit of the amount is not particularly limited, it may be 200000 parts by mass or less, 20000 parts by mass or less, 2000 parts by mass or less, or 200 parts by mass or less.

The content (concentration) of the component (A), (B), or (C) in the acetic acid-containing composition of one or more embodiments of the present invention can be determined based on the amount thereof incorporated and the volume of the acetic acid-containing composition when the amount of the component incorporated is apparent (e.g., when the acetic acid-containing composition is obtained by mixing the purified components). When the amount of the component incorporated is unknown, the content (concentration) of interest can be determined by or in accordance with the method described below. The unit “ppb” or “ppm” used herein indicates mass concentration (w/w), which expresses the mass of the solute relative to the mass of the whole solution. The unit “% by mass” or “mass %” (may be denoted as “w/w %”) used herein expresses the mass of the solute relative to the mass of the whole solution as percentage.

The content of the component (A), (B), or (C) in the acetic acid-containing composition of one or more embodiments of the present invention is as indicated above when the acetic acid-containing composition is to be eaten or used without further processing. That is, the content of the component (A), (B), or (C) in the acetic acid-containing composition of one or more embodiments of the present invention is the content when it is eaten or used. In the case of a concentrated liquid seasoning, for example, the content of the component (A), (B), or (C) in the diluted liquid seasoning would be in the range indicated above. When the total content of the components (A) to (C) is 100 ppb in, for example, a 10-fold concentrate, specifically, the content thereof would be 10 ppb when it is eaten.

### (Food or Beverage Product)

The acetic acid-containing composition according to an aspect of one or more embodiments of the present invention may be a food or beverage product. In one or more embodiments of the present invention, a food or beverage product is a composition that is fully made from materials suitable for use in food. When a food additive is used, in particular, a food additive that is approved for use in food by the Food Sanitation Law in Japan. Specifically, a composition comprising a component that is not approved for use in food by the Food Sanitation Law in Japan is a non-food or beverage product. For example, a surfactant, which is a component that is not approved for use in food by the Food Sanitation Law in Japan, may be added to prepare a non-food or beverage product. More specifically, polyoxyethylene alkyl ether may be added in an amount of 1% to prepare an acetic acid-containing composition, which is a non-food or beverage product, or a cleaner, which is a non-food or beverage product. While the content of the component is not particularly limited, it may be 0.1% by mass to 10% by mass. Specifically, the lower limit of the content may be 0.1% by mass or more, 0.2% by mass or more, 0.5% by mass or more, or 1.0% by mass or more. While the upper limit of the content is not particularly limited, in general, it is 10% by mass or less or 5.0% by mass or less.

A food or beverage product is not particularly limited, provided that it is an acetic acid-containing food or beverage product. A specific example of an acetic acid-containing food or beverage product is vinegar or a food or beverage product prepared with the use of vinegar as a raw material.

The vinegar is either fermented vinegar or synthetic vinegar. The fermented vinegar is produced with the use of grains (e.g., rice or barley) or fruit juice as a main raw material, and the synthetic vinegar is produced with the addition of a seasoning (e.g., sugar) or fermented vinegar to a diluted solution of glacial acetic acid or acetic acid. Both thereof can be used in one or more embodiments of the present invention. Examples of fermented vinegar products include grain vinegar (e.g., rice vinegar, brown rice vinegar, black vinegar, vinegar made from fermented sake lees, malt vinegar, coix seed vinegar, and soybean vinegar), fruit vinegar (e.g., apple vinegar, grape vinegar, white grape vinegar, citrus (e.g., lemon, Citrus junos, Citrus sphaerocarpa, orange, tangerine, Citrus depressa, and grapefruit) vinegar, mango vinegar, strawberry vinegar, blueberry vinegar, pomegranate vinegar, peach vinegar, Prunus mume vinegar, pineapple vinegar, blackcurrant vinegar, raspberry vinegar, wine vinegar, and balsamic vinegar), spirit vinegar produced by acetic acid fermentation with the use of ethanol as a raw material, Chinese vinegar, and sherry vinegar. An example of synthetic vinegar is vinegar that is prepared by adequately diluting glacial acetic acid or acetic acid with water. Any of such vinegar products may be used by itself or in combination of two or more.

Of food or beverage products produced with the use of vinegar as a raw material, examples of beverage products include: vinegar beverages, such as a grain vinegar beverage, a fruit vinegar beverage, and a vinegar beverage containing fruit juice; and various beverage products containing vinegar, such as beverage products containing dairy products (e.g., a beverage containing a milk constituent, such as milk or a processed product of milk; i.e., non-fat milk powder or whole milk powder, evaporated milk, yogurt, dairy cream, condensed milk, butter, dried milk, sweetened powdered milk, formula milk, whey powder, or buttermilk powder), vegetable beverages (e.g., a tomato, carrot, or pumpkin juice, a smoothie, and a green juice), refreshing beverages (e.g., a sports supplement drink, a fruit ade beverage such as a lemonade, and a fruit-flavored beverage), a carbonated drink, a jelly drink, grain beverages (e.g., a grain beverage mainly composed of rice, soymilk, or almond), tea-based beverages (e.g., black tea, oolong tea, green tea, fermented black tea, green powdered tea, jasmine tea, rosehip tea, chamomile tea, roasted green tea, and elderflower tea), a coffee beverage, and alcoholic beverages (e.g., beer, a beer-like beverage such as low-malt beer, brewed alcoholic beverages such as fruit liquor or Sake (Japanese rice wine), distilled liquor such as Shochu (distilled alcoholic beverage), whisky, brandy, or spirit, mixed liquor prepared by mixing an auxiliary raw material such as sugar into distilled liquor, and a cocktail, fizz, or shochu-based beverage prepared by adding fruit juice, flavor, or carbon dioxide to an alcoholic beverage. A beverage may be concentrated. A concentrated beverage product may be first diluted with an adequate beverage and subjected to drinking. A recommended dilution factor may be, for example, 1.1- to 50-fold, 2- to 20-fold, 3- to 12-fold, or 4- to 8-fold.

Examples of the food or beverage products of one or more embodiments of the present invention other than beverage products include dessert sauces (e.g., a fruit sauce such as a strawberry, blueberry, apple, raspberry, or pomegranate sauce, a caramel sauce, a custard sauce, and a chocolate sauce), conserves (e.g., strawberry, apple, grape, fig, blueberry, raspberry, blackberry, and mango conserves), spreads (e.g., cream, cheese, margarine, and fat spreads), confectionaries (e.g., jelly, pudding, bavarois, and mousse), frozen desserts (e.g., ice cream, sherbet, and smoothie), seasoned vinegar (e.g., ponzu, ponzu soy sauce, sweet vinegar, seasoned vinegar for vinegared food, seasoned vinegar for sushi rice, and liquid seasoning for pickled food (e.g., pickles)), mayonnaise, chutney, mustard, dressings (e.g., oil-free dressing, separate dressing, and emulsified dressing), dipping sauces (e.g., a sesame-containing seasoning such as sesame sauce and barbeque sauce), cooking sauces (e.g., Worcestershire sauce, ketchup, oyster sauce, salsa sauce, sambal sauce, and chili sauce), tsuyu (Japanese soup broth; e.g., mentsuyu (noodle soup base), nabetsuyu (hot pot soup)), seasoning for various dishes (seasoning for rice, seasoning for Chinese dishes, seasoning for stewed dishes and seasoning for fermented soy beans), fermented food or beverage products (e.g., pickles, kimchi, yogurt, probiotic drinks, and fermented milk drinks), and vinegar-containing cooked foods (e.g., sushi, vinegared food, salad, sweet and sour pork, and pickled food).

food).

The target food or beverage products of one or more embodiments of the present invention include food other than pharmaceuticals, which can be taken for the purpose of the maintenance or improvement of health, such as health food, functional food, food with health claims, and food for special dietary uses, in addition to common food or beverage products described above. Health food includes those available under the name of a nutritional supplement, dietary supplement, or supplement. Food with health claims, which is defined in the Food Sanitation Act and the Health Promotion Act, includes: foods for specified health uses and foods with nutrient function claims which can be labeled with specific health effects, function of nutrient components, and reduction of disease risk; and foods with function claims which can be labeled with the function based on scientific evidence submitted to the Commissioner of the Consumer Affairs Agency. Foods for special dietary uses include food for sick people, food for the elderly, food for infants, and food for pregnant and nursing women, which can be labeled with suitability for specific persons or patients with specific disease. Labeling of specific health effects, function of nutrient components etc. on a food or beverage product may be on the container, the package, documents such as instructions and package inserts of the product, flyers and pamphlets of the product, and the advertisement of the product in newspaper or magazines.

The form of the food or beverage product may be any edible form such as a solid, liquid, granules, particles, powder, capsules, cream, or paste form.

The food or beverage product of one or more embodiments of the present invention may also comprise other raw materials depending on the type of the food or beverage product. Examples of other raw materials include proteins, peptides, amino acids, vitamins, minerals (e.g., calcium, potassium, and sodium), lipids (e.g., plant oil, fish oil, and animal oil), sweeteners (e.g., glucose, sucrose, fructose, high fructose corn syrup, aspartame, and stevia), flavors (e.g., esters, alcohols, aldehydes, ketones, acetals, phenols, ethers, lactones, furans, hydrocarbons, nitrogen-containing compounds, and sulfur-containing compounds), smashed materials prepared by cutting and/or smashing fruit and/or vegetables (extract juice (fruit juice and vegetable juice), puree, or paste), salt, amino acid seasoning, nucleic acid seasoning, organic acid seasoning, acidulant, a flavor ingredient, a umami seasoning, liquor, oil and fat, spice, spice extract, flavor oil, viscosity adjustor, colorant, and ingredients. The combination and the content of these raw materials are not particularly limited and may be set depending on the type of the food or beverage product.

These acetic acid-containing food or beverage products can be produced by a common method except for the addition of one or more components selected from the group consisting of (A) 2-octenal, (B) (+)-rose oxide, and (C) 1,8-cineole. For example, a vinegar beverage can be produced by adding one or more components selected from among (A), (B), and (C), fruit juice, honey, and the like to vinegar and adequately diluting the mixture. Furthermore, ponzu soy sauce can be produced by adding one or more components selected from among (A), (B), and (C), soy sauce, sugar, salt, citrus fruit juice, and spice to vinegar. In addition, sushi vinegar can be produced by adding, for example, one or more components selected from among (A), (B), and (C), seasoning such as sugar, salt, and mirin (sweet sake) to vinegar.

### (Cleaner Composition)

The acetic acid-containing composition according to another aspect of one or more embodiments of the present invention may be a cleaner composition. A cleaner composition is not particularly limited, provided that it contains acetic acid.

The cleaner composition of one or more embodiments of the present invention may be used as a house, kitchen, bathroom, or washroom cleaner. Specifically, the cleaner composition of one or more embodiments of the present invention can be directly disseminated or sprayed to a target object with the use of a disseminator or sprayer, or it can be impregnated into a dust cloth and applied to a target object. Examples of target objects include: wall and floor surfaces of a living room and an entrance; surfaces of doorknobs and handrails; surfaces of infant or toddler products (e.g., child safety seats); wall and floor surfaces of a kitchen and a cooking area; surfaces and inner surfaces of a sink, a kitchen range, a refrigerator, and an oven; wall and floor surfaces of a bathroom and surfaces of a bathtub and a wash ball; and wall and floor surfaces of a washroom and a surface of a toilet ball.

A form of the cleaner composition of one or more embodiments of the present invention may be any of a liquid, emulsion, gel, paste, solid, or powder form, with a liquid form being preferable. A cleaner composition in a liquid form can be prepared in a preferable form of the cleaner composition of one or more embodiments of the present invention, such as a spray agent suitable for spraying and/or ejection with the aid of compressed gas or a pump. A container used for the cleaner composition of one or more embodiments of the present invention in the form of a spray agent is not particularly limited. For example, a trigger spray container (a direct pressure or accumulator system) or a dispensing spray container is preferable.

The cleaner composition of one or more embodiments of the present invention can be produced by preparing a solution of acetic acid and one or more components selected from among (A), (B), and (C) described above with the use of a surfactant and a liquid carrier, according to need, mixing the solution with an adequate amount of water, and string the mixture. Examples of liquid carriers used herein include: alcohols, such as methanol, ethanol, isopropyl alcohol, butanol, hexanol, benzyl alcohol, and ethylene glycol; ethers, such as diethyl ether, ethylene glycol dimethyl ether, diethylene glycol monomethyl ether, diethylene glycol monoethyl ether, and propylene glycol monomethyl ether; esters, such as ethyl acetate, butyl acetate, isopropyl myristate, and ethyl lactate; ketones, such as acetone, methyl ethyl ketone, methyl isobutyl ketone, and cyclohexanone; aromatic or aliphatic hydrocarbons, such as xylene, toluene, alkyl naphthalene, phenyl xylyl ethane, kerosine, light oil, hexane, and cyclohexane; halogenated hydrocarbons, such as chlorobenzene, dichloromethane, dichloroethane, and trichloroethane; nitriles, such as acetonitrile and isobutyronitrile; sulfoxides, such as dimethyl sulfoxide; heterocyclic solvents, such as sulfolane, γ-butyrolactone, N-methyl-2-pyrrolidone, and N-ethyl-2-pyrrolidone; acid amides, such as N,N-dimethylformamide and N—N-dimethylacetamide; plant oil, such as soybean oil and cottonseed oil; plant essential oil, such as orange oil, Hyssopus officinalis oil, and lemon oil; and water.

Examples of surfactants used for preparing the cleaner composition of one or more embodiments of the present invention include anionic surfactant, nonionic surfactant, and amphoteric surfactant.

Examples of anionic surfactants include alkyl benzene sulfonate, lignosulfonate, alkyl sulfosuccinate, naphthalene sulfonate, alkyl naphthalene sulfonate, salt of formalin condensate of naphthalene sulfonic acid, salt of formalin condensate of alkyl naphthalene sulfonic acid, polyoxyethylene alkyl aryl ether sulfate and phosphate, polyoxyethylene styryl phenyl ether sulfate and phosphate, polycarboxylate, and polystyrene sulfonate.

Examples of nonionic surfactants include polyoxyethylene alkyl ether, polyoxyethylene alkyl phenyl ether, polyoxyethylene allyl phenyl ether, polyoxyethylene styryl phenyl ether, a polyoxyethylene alkyl phenyl ether formaldehyde condensate, a polyoxyethylene-polyoxypropylene block polymer, sorbitan fatty acid ester (e.g., sorbitan monooleate and sorbitan laurate), polyoxyethylene fatty acid ester, polyoxyethylene sorbitan fatty acid ester, polyoxyethylene hydrogenated castor oil, and polyethylene glycol fatty acid ether.

Examples of amphoteric surfactants include alkylamine oxide, an amino acid type surfactant, an N-acyl amino acid type surfactant, a betaine type amphoteric surfactant, and a sulfonic acid type amphoteric surfactant.

Any of the surfactants may be used by itself or in combination of two or more. While the content of a surfactant in the cleaner composition varies depending on a surfactant type, for example, the content is in a range of 0.1% to 10% by weight.

The cleaner composition of one or more embodiments of the present invention may further contain other components, according to need. Other components are not particularly limited, provided that such components are generally used for a cleaner composition. Examples thereof include a polyol, a stabilizer, an inorganic salt, a viscosity modifier, a chelating agent, a pigment (colorant), an emulsifier, a pH modifier, a cleaning aid, a dispersant, an enzyme, a foam modifier, an antiredeposition agent, a solvent, a hydrotropic agent, and a water softening agent.

The content of acetic acid in the acetic acid-containing composition of one or more embodiments of the present invention can be quantified by, for example, the method described below. The sample is diluted with ultrapure water, so as to adjust the concentration of acetic acid to approximately 0.1 w/v %, and the peak area of acetic acid is analyzed by high performance liquid chromatography (HPLC) under the conditions described below. The samples are analyzed in the same manner with the use of 0.1 w/v % acetic acid diluted with ultrapure water as a standard sample to determine the content of acetic acid in the samples by the external standard method.

### <High Performance Liquid Chromatography (HPLC) Conditions>

Apparatus: Model LC-10ADVP, Shimadzu Corporation
Mobile phase (1): 4 mM p-toluene sulfonic acid aqueous solution; flow rate: 0.9 ml/minute
Mobile phase (2): 16 mM Bis-tris aqueous solution containing 4 mM p-toluene sulfonic acid and 80 μM EDTA; flow rate: 0.9 ml/minute
Columns: Shodex KC810P+KC-811×2 (SHOWA DENKO K.K.)
Column temperature: 50° C.
Detection: Conductivity Detector CDD-10_{VP} (Shimadzu Corporation)

The content of (A) 2-octenal, that of (B) (+)-rose oxide, and that of (C) 1,8-cineole in the acetic acid-containing composition of one or more embodiments of the present invention can be quantified by, for example, the stir bar sorptive extraction (SBSE) method using the gas chromatography mass spectrometer (GC/MS) shown below.

Standard preparations of components of known contents are diluted with 99.5% ethanol to adjust the concentration to 1000 ppm, the resultants are further diluted with ultrapure water to adjust the concentration to adequate levels (i.e., diluted standard preparations), and the diluted standard preparations and samples are then analyzed. The diluted standard preparations (10 ml) and the samples (10 ml) are each stirred with two stir bars (Twister, GERSTEL) for 2 hours, so as to adsorb the components to the polydimethylsiloxane (PDMS) layers of the stir bars, and the stir bars are then subjected to analysis. The target components in the samples were quantified by comparing the results of the integrated peak areas of the amounts of confirmation ions detected in the diluted standard preparations and those of the samples at the retention times, which were considered to be of the target components in comparison with the retention times of the standard preparations, by the analysis based on the mass spectral patterns obtained using a mass spectrometer. Regarding 2-octenal, m/z=41, 55, 70, and 83 were detected at retention times around 20 to 23 minutes; regarding (+)-rose oxide, m/z=69 and 139 were detected at retention times around 16 to 22 minutes; and regarding 1,8-cineole, m/z=43, 81, and 154 were detected at retention times around 12 to 17 minutes. At the retention time in which the above ions were significally detected in common, the results of integrating peak area at m/z=41 for 2-octenal, peak area at m/z=139 for (+)-rose oxide, and peak area at m/z=43 for 1,8-cineole were measured.

### <Gas Chromatography Mass Spectrometer (GC/MS) Conditions>

Apparatuses: 7890B (GC) and 5977B (MS) (Agilent), MultiPurpose Sampler (auto-sampler) (Gester)
Adsorption resin: TENAX
Incubation temperature: 80° C.
Amount of nitrogen gas purge: 60 ml
Flow rate of nitrogen gas purge: 10 ml/min
TDU: [30° C.]-[720° C./min]-[240° C. (3 min)]
CIS: [10° C.]-[12° C./sec]-[240° C.]

As a capillary column, DB-WAX (length: 30 m; inner diameter: 250 μm; membrane thickness: 0.25 μm, for LTM, Agilent) can be used as one-dimensional column. As carrier gas, helium can be used.

### 2. The Agent for Masking Acetic Acid Odor

One or more embodiments of the present invention also provide an agent for masking acetic acid odor comprising one or more components selected from the group consisting of (A) 2-octenal, (B) (+)-rose oxide, and (C) 1,8-cineole. The agent for masking acetic acid odor according to an aspect of one or more embodiments of the present invention can comprise one or more components selected from among (A), (B), and (C) described above in an amount of, for example, 1 to 100 parts by mass, 20 to 100 parts by mass, 40 to 100 parts by mass, 60 to 100 parts by mass, 80 to 100 parts by mass, 90 to 100 parts by mass, 95 to 100 parts by mass, 99 to 100 parts by mass, or 99.9 to 100 parts by mass, relative to 100 parts by mass of the agent for masking acetic acid odor.

The term “the agent for masking acetic acid odor” used herein refers to an agent that can be blended in the acetic acid-containing composition in the process of producing the composition. A form (dosage form) of the agent for masking acetic acid odor of one or more embodiments of the present invention is not particularly limited. For example, any of a liquid, fluid, gel, solid, or semisolid form may be employed. The agent for masking acetic acid odor of one or more embodiments of the present invention may comprise additives and the like that are acceptable for use in food or beverage products and used to prepare the agent for masking acetic acid odor of one or more embodiments of the present invention in a form (dosage form) of interest, in addition to one or more components selected from (A) 2-octenal, (B) (+)-rose oxide, and (C) 1,8-cineole, as long as such additives do not interfere the effects of suppressing acetic acid odor. Examples of additives include a surfactant, an excipient, a diluent, a binder, a disintegrator, an emulsifier, a dispersant, a solubilizer, a buffer, a thickening agent, a gelling agent, a stabilizer, a preservative, and a suspension agent. Types and amounts of additives can adequately be selected in accordance with one or more embodiments of the use of the agent for masking acetic acid odor of one or more embodiments of the present invention.

### 3. A Method for Producing an Acetic Acid-Containing Composition and a Method for Suppressing Acetic Acid Odor

One or more embodiments of the present invention also provide a method for producing an acetic acid-containing composition with suppressed acetic acid odor comprising a step of adding one or more components selected from among (A) 2-octenal, (B) (+)-rose oxide, and (C) 1,8-cineole to an acetic acid-containing composition to a given content and a method for suppressing acetic acid odor of an acetic acid-containing composition.

A timing at which one or more components selected from among (A) 2-octenal, (B) (+)-rose oxide, and (C) 1,8-cineole are added to the acetic acid-containing composition is not particularly limited. Such timing can be, for example, during an acetic acid-containing composition is produced, after the acetic acid-containing composition is produced, or before the acetic acid-containing composition is eaten or used. The content of acetic acid in the acetic acid-containing composition and the origin and the amount of one or more components selected from among (A), (B), and (C) described above added to the acetic acid-containing composition are as described above. After one or more components selected from among (A), (B), and (C) are added to the acetic acid-containing composition, it is preferable that such components be mixed and dispersed as homogeneous as possible therein, according to need.

A preferable embodiment of the method for producing the acetic acid-containing composition comprises the following steps (i) and (ii):
(i) a step of preparing an acetic acid-containing composition containing acetic acid at 0.02 w/v % or higher; and
(ii) a step of adding one or more components selected from the group consisting of (A) 2-octenal, (B) (+)-rose oxide, and (C) 1,8-cineole to the acetic acid-containing composition obtained in the step (i).

In the step (ii), one or more components selected from the group consisting of (A) 2-octenal, (B) (+)-rose oxide, and (C) 1,8-cineole may be derived from a preparation, such as a flavor, or a seasoning or food raw material to be blended in a food or beverage product. When such components are derived from a food raw material or the like, a plant material containing one or more components selected from the group consisting of (A), (B) and (C) can be used. A plant material is not particularly limited, provided that such plant contains one or more components selected from the group consisting of (A) 2-octenal, (B) (+)-rose oxide, and (C) 1,8-cineole. Examples thereof include grape, apricot, melon, water melon, mango, kiwi fruit, rosemary, olive, elderflower, rose, geranium, lemongrass, yellow batai, eucalyptus, peppermint, fenugreek, chamomile, cardamom, cumin, apple mint, laurel, cinnamon, rosehip, thyme, and nutmeg. One of such plant materials may be used by itself, or two or more thereof may be used in combination. The plant materials may be used in any state, such as a fresh, dried, or freeze-dried state. The act of “adding” is to mix the acetic acid-containing composition prepared in the step (i) with one or more components selected from among (A), (B), and (C).

It is also possible to use an extract of the plant material. When an extract is used, it is preferable to perform a step of extracting the plant material in the step (ii). Extraction is to separate a component that is soluble in a solvent contained in a raw material with the use of a solvent. The plant material is added to a solvent, the mixture is allowed to stand, and the resultant is then filtered. Thus, an extract can be prepared. Alternatively, the solvent supplemented with the plant material is heated to a given temperature, and the resultant is allowed to stand or held at constant temperature with stirring. Thus, the extract of interest can be prepared. Any solvent suitable for use in food can be used for extraction without particular limitation. Examples thereof include water, ethanol, ethyl acetate, acetic acid, propanol, and hexane, and any thereof may be used by itself or in combination of two or more.

From the viewpoint of extraction efficiency, a pH level of an extraction solvent is from acidic to neutral levels. Specifically, a pH level may be 1.0 or higher, 2.0 or higher, 2.1 or higher, 2.2 or higher, 2.3 or higher, 2.4 or higher, 2.5 or higher, 2.6 or higher, 2.7 or higher, 2.8 or higher, 2.9 or higher, 3.0 or higher, 3.2 or higher, 3.4 or higher, 3.6 or higher, or 3.8 or higher, while the upper limit may be less than 8.0, less than 7.5, less than 7.0, less than 6.5, less than 6.0, less than 5.5, less than 5.0, less than 4.6, or less than 4.0. In the method of one or more embodiments of the present invention, a pH level of an extraction solvent may be modified after the step of adding a plant material containing one or more components selected from the group consisting of (A) 2-octenal, (B) (+)-rose oxide, and (C) 1,8-cineole to the extraction solvent. Alternatively, a plant material containing one or more components selected from the group consisting of (A) 2-octenal, (B) (+)-rose oxide, and (C) 1,8-cineole may be added to the extraction solvent with a pH previously modified within a given range. A pH level can be modified by dissolving a pH modifier (e.g., sodium hydroxide, potassium hydroxide, potassium carbonate, calcium carbonate, potassium gluconate, lactic acid, citric acid, tartaric acid, malic acid, or acetic acid) in an extraction solvent.

A solvent used for extraction may be heated, according to need. While heating conditions are not particularly limited, for example, heating temperature can be in a range of 20° C. to 105° C., and a heating period can be in a range of 30 seconds or longer and less than 30 minutes. More specifically, the lower limit of the heating temperature is, for example, 20° C. or higher, 25° C. or higher, 30° C. or higher, 40° C. or higher, 50° C. or higher, 55° C. or higher, 60° C. or higher, 65° C. or higher, 70° C. or higher, 75° C. or higher, 80° C. or higher, 85° C. or higher, 90° C. or higher, or 95° C. or higher, while the upper limit thereof is, in general, 105° C. or lower or 100° C. or lower. The lower limit of the heating period is, for example, 30 seconds or longer, 1 minute or longer, 2 minutes or longer, or 3 minutes or longer, while the upper limit thereof is, in general, less than 1500 minutes, less than 1200 minutes, less than 1000 minutes, less than 600 minutes, less than 300 minutes, less than 180 minutes, less than 60 minutes, less than 30 minutes, less than 25 minutes, less than 20 minutes, less than 15 minutes, less than 10 minutes, or less than 5 minutes. In general, there is an approximately co-dependent relationship between a heating temperature and a heating period. While the heating period can generally be shorter as the heating temperature is raised, the heating temperature can generally be lower as the heating period is prolonged. From the viewpoint of the relationship between the heating temperature and the heating period, adequate ranges of the heating temperature and of the heating period may be determined. Specifically, extraction with heating may be performed at 70° C. to 105° C. for less than 25 minutes, at 80° C. to 105° C. for less than 20 minutes, or at 85° C. to 105° C. for less than 15 minutes.

The amount of the solvent to be used is not particularly limited. For example, such amount may be at least 10 times, or at least 20 times the amount of the plant material (dry weight). When extraction is followed by concentration or isolation, such amount may be up to 100 times for the convenience of operation. A plant extract can be used for the acetic acid-containing composition of one or more embodiments of the present invention without further processing. According to need, the extract may be subjected to concentration, drying treatment, such as hot air drying, vapor drying, freeze drying, or spray drying, separation and purification, or decolorization, and the resulting concentrated or dried product may then be used.

One or more components selected from the group consisting of (A) 2-octenal, (B) (+)-rose oxide, and (C) 1,8-cineole contained in the acetic acid-containing composition of one or more embodiments of the present invention may be a substance that is contained in a food material such as an edible plant serving as a raw material of the acetic acid-containing composition, a substance that is added separately from the food material when producing the composition of one or more embodiments of the present invention, or a substance that is generated when producing the composition of one or more embodiments of the present invention. Alternatively, the total of one or more components selected from the group consisting of (A) 2-octenal, (B) (+)-rose oxide, and (C) 1,8-cineole derived from two or more thereof may satisfy the given content and/or proportion described above. When one or more components selected from the group consisting of (A) 2-octenal, (B) (+)-rose oxide, and (C) 1,8-cineole are added externally at the time of production of the composition of one or more embodiments of the present invention, a reagent of a highly-purified (A), (B) or (C) extract may be added, or a processed plant material containing one or more components selected from the group consisting of (A) 2-octenal, (B) (+)-rose oxide, and (C) 1,8-cineole (e.g., an extract) may be added. More than a half (more preferably the whole) of one or more components selected from the group consisting of (A) 2-octenal, (B) (+)-rose oxide, and (C) 1,8-cineole to be contained in the composition may be derived from a food material, or from an edible plant. More specifically, such components may be derived from one or more members selected from among grape, apricot, melon, water melon, mango, kiwi fruit, rosemary, olive, elderflower, rose, geranium, lemongrass, yellow batai, eucalyptus, peppermint, fenugreek, chamomile, cardamom, cumin, apple mint, laurel, cinnamon, rosehip, thyme, and nutmeg, with elderflower or cardamom being more preferable. The term “processed plant material” used herein refers to a treated product of a plant material containing one or more components selected from the group consisting of (A) 2-octenal, (B) (+)-rose oxide, and (C) 1,8-cineole by means of, for example, drying, grinding, extraction, or purification.

The plant material used for extraction may be used in any state, such as a fresh, dried, or freeze-dried state. From the viewpoint of extraction efficiency, a raw material may be a dried plant material. Examples of drying techniques include, but are not particularly limited to, hot air drying, freeze drying, vacuum drying, spray drying, and drum drying.

When an extract of plant material is used in the step (ii), it is preferable that the content of dietary fiber in the extract of plant material be adjusted to a given level or lower from the viewpoint of viscosity or smoothness. More specifically, the content of dietary fiber in the acetic acid-containing composition in the step (ii) may be 10% by mass or less, 8% by mass or less, or 5% by mass or less than the content of dietary fiber in the acetic acid-containing composition in the step (i). While the lower limit is not particularly limited, in general, it may be 0% by mass or more, 1% by mass or more, or 2% by mass or more.

The content of dietary fiber (mass %) can be measured by the enzymatic-gravimetric method (the Prosky method). The “dietary fiber” can be clearly determined with reference to the “Total Amount of Dietary fiber” section in the Standard Tables of Food Composition in Japan—2020—(Eighth Revised Version).

When performing a step of extracting a plant material in the step (ii), whether or not each component has been sufficiently extracted can be determined with the use of a haze value of the extract as the indicator. The “haze value” can be determined by dividing the diffusive transmittance by the total transmittance. Specifically, the “haze value” is determined in accordance with an equation: haze value (%)=diffusive transmittance/total transmittance×100. In the equation, the “total transmittance” is the light transmittance determined in consideration of reflection and scattering, and the “diffusive transmittance” is transmittance of diffused light except for the component that is in parallel in the direction of the light beam among light beams that are transmitted through samples. The total transmittance and the diffusive transmittance are determined in accordance with a conventional technique of transmission measurement performed with the use of a turbidity meter based on Integrated photoelectric photometry (WA6000T; Nippon Denshoku Industries Co. Ltd.) by introducing the sample adjusted to 20° C. into a quartz cell with the optical path length of 5 mm, and employing distilled water as a control. The “haze value” can be more clearly evaluated and measured with reference to ISO 14782: 1999.

For example, 2 parts by mass of plant materials are added to 98 parts by mass of water (pH 7.0) adjusted to 90° C., held at 90° C. for 3 minutes, and cooled to room temperature (25° C.) in a water bath. Thereafter, the haze value is measured. When the haze value is determined to be a level equivalent to or higher than a given level, the effects of one or more embodiments of the present invention to suppress acetic acid odor can be achieved when components are extracted sufficiently and incorporated into the acetic acid-containing composition.

When a step of extracting a plant material is performed in the step (ii), specifically, a difference in haze values before and after extraction may be 0.3% to 20%. More specifically, the lower limit thereof may be 0.3% or more, 0.6% or more, or 1% or more. While the upper limit thereof is not particularly limited, it is generally 20% or less, it may be 18% or less, or 15% or less. While the cause thereof is unknown, a haze value is deduced to increase when a plant pigment included in the plant material is extracted. When an extract of plant material is an extract of grape, apricot, melon, water melon, mango, kiwi fruit, rosemary, olive, elderflower, rose, geranium, lemongrass, yellow batai, eucalyptus, peppermint, fenugreek, chamomile, cardamom, cumin, apple mint, laurel, cinnamon, rosehip, thyme, or nutmeg, in particular, a pigment in the plant effectively acts. Accordingly, it is preferable to perform the extraction described above.

While the haze value of the extract of plant material of one or more embodiments of the present invention is generally 0.3% or higher, it may be 0.6% or higher, or 1% or higher. While the upper limit thereof is not particularly limited, it may be generally 20% or lower, 18% or lower, or 15% or lower.

A step (iii) of modifying a pH level of the extract obtained after a step of extracting a plant material in the step (ii) (such extract may be simply referred to as “the step (ii) extract”) to a relatively acidic level may further be performed. The technical significance thereof resides in immobilizing the constituents of one or more embodiments of the present invention by modifying a pH level of the step (ii) extract to an acidic level relative to the pH level in the step of extraction. More specifically, it is possible to modify a pH level, so as to adjust a difference in a pH level of the step (ii) extract (i.e., the extract obtained after the step of extraction in the step (ii)) lowered from the pH level of the extraction solvent used in the step (ii) to 0.1 to 8.0. More specifically, the lower limit thereof may be 0.1 or more, 0.2 or more, 0.3 or more, 0.4 or more, 0.5 or more, 0.6 or more, 0.7 or more, 0.8 or more, 0.9 or more, or 1.0 or more, and the upper limit thereof may be 8.0 or less, 7.0 or less, 6.0 or less, 5.0 or less, 4.0 or less, or 3.0 or less. When it is impossible to measure a pH level because, for example, an extraction solvent does not contain water, a difference in lowering can be determined by designating the pH level of the extraction solvent as 7.0.

A pH level of the extract that has been modified to a relatively acidic level in the step (iii) may be modified in a given range. In the method of one or more embodiments of the present invention, specifically, a pH level of the extract that has been modified to a relatively acidic level in the step (iii) may be modified to 1.0 or higher and less than 7.0. More specifically, such pH level may be 1.0 or higher, 2.0 or higher, 2.1 or higher, 2.2 or higher, 2.3 or higher, 2.4 or higher, 2.5 or higher, 2.6 or higher, 2.7 or higher, 2.8 or higher, 2.9 or higher, 3.0 or higher, 3.2 or higher, 3.4 or higher, 3.6 or higher, or 3.8 or higher, while the upper limit is less than 7.0, less than 6.5, less than 6.0, less than 5.5, less than 5.0, less than 4.6, or less than 4.0.

When modifying a pH level of the step (ii) extract in the method of one or more embodiments of the present invention, a pH level may be modified to a relatively acidic level by dissolving a pH modifier (e.g., lactic acid, citric acid, tartaric acid, malic acid, or acetic acid) in an extraction solvent. Also, a pH level of the step (ii) extract may be modified to a relatively acidic level with the aid of the component extracted from the target plant material. Alternatively, a food may be added to an extract, or an extract may be added to a food, so as to modify a pH level of the entire food containing the extract to a relatively acidic level with the aid of the buffer capacity of the food.

### EXAMPLES

Hereafter, one or more embodiments of the present invention are described in greater detail with reference to the examples, although one or more embodiments of the present invention are not limited to the examples.

### Test Example 1

### (1) Preparation of Test Product

Acetic acid (Kanto Chemical Co., Inc.) was diluted with ultrapure water to prepare an aqueous solution of 4 w/v % acetic acid.

The components to be analyzed: i.e., 2-octenal (Tokyo Chemical Industry Co., Ltd.), (+)-rose oxide (Sigma-Aldrich), and 1,8-cineole (Tokyo Chemical Industry Co., Ltd.), were each added to 99.5% ethanol (Kanto Chemical Co., Inc.), and the mixtures were thoroughly stirred to prepare 1,000 ppm solutions. The resulting solutions were diluted with ultrapure water to prepare diluted solutions of the components to be analyzed.

The diluted solutions of the components to be analyzed were added to the concentration as shown in Table 1 in the aqueous solution of 4 w/v % acetic acid to prepare test products (A1 to A6, B1 to B6, and C1 to C6). An aqueous solution containing acetic acid at the equivalent concentration but not supplemented with the components to be analyzed was used as a control sample.

### (2) Sensory Evaluation Test

### (Selection of Professional Panelists for Sensory Evaluation)

The following differentiation trainings (I) and (II) were performed, and persons who have made remarkable achievements were selected as professional panelists for sensory evaluation.
(I) A taste differentiation test to accurately differentiate a sample of a relevant taste from among 7 samples: i.e., aqueous solutions each containing any of five tastes (sweet: a taste of sugar; sour: a taste of tartaric acid; umami: a taste of sodium glutamate; salty: a taste of sodium chloride; and bitter: a taste of caffeine) at a concentration close to the threshold thereof and 2 samples of distilled water.
(ii) A concentration differentiation test to accurately differentiate differences in concentrations among 5 types of aqueous solutions each containing saline at slightly different concentration and an aqueous solution containing acetic acid.

### (Method of Evaluation and Evaluation Criteria)

On the assumption that samples were acetic acid-containing beverage products, suppression of the acetic acid odor was evaluated in the manner described below. The test products or a control sample (10 ml each) were introduced into colored brandy glasses, and the selected 10 professional panelists for sensory evaluation smelled the samples to evaluate the acetic acid odor.

### (Evaluation Criteria)

Evaluation was performed in accordance with the following criteria. The scores determined by 10 professional panelists for sensory evaluation were averaged, the average score was rounded down to the second decimal point, and the resultant was designated as the final score. Of the characteristic points other than the evaluation criteria, representative opinions were recorded as remarks.
5 points: Acetic acid odor equal to that of the control
4 points: Acetic acid odor slightly weaker than that of the control
3 points: Acetic acid odor somewhat weaker than that of the control
2 points: Acetic acid odor weaker than that of the control
1 point: Acetic acid odor significantly weaker than that of the control

The results are shown in Table 1.

TABLE 1

| | | | Concentration | Evaluation of |
|---|---|---|---|---|
| Test | | Acetic acid | of component | acetic acid odor |
| product | Component | (w/v %) | (ppb) | (point) |
| Control | Not added | 4 | 0 | 5.0 |
| A1 | 2-Octenal | 4 | 0.01 | 3.5 |
| A2 | | | 0.1 | 3.3 |
| A3 | | | 1 | 3.8 |
| A4 | | | 10 | 2.8 |
| A5 | | | 100 | 2.3 |
| A6 | | | 1000 | 1.8 |
| B1 | (+) Rose oxide | 4 | 0.01 | 3.2 |
| B2 | | | 0.1 | 2.8 |
| B3 | | | 1 | 3.8 |
| B4 | | | 10 | 2.3 |
| B5 | | | 100 | 2.3 |
| B6 | | | 1000 | 2.7 |
| C1 | 1,8-Cineole | 4 | 0.01 | 3.2 |
| C2 | | | 0,1 | 3.5 |
| C3 | | | 1 | 3.2 |
| C4 | | | 10 | 2.7 |
| C5 | | | 100 | 2.8 |
| C6 | | | 1000 | 2.7 |

As shown in Table 1, 2-octenal, (+)-rose oxide, and 1,8-cineole were found to suppress the acetic acid odor.

### Test Example 2

### (1) Preparation of Test Solution

In the same manner as in Test Example 1, two or more of the diluted solutions of the components to be evaluated: 2-octenal, (+)-rose oxide, and 1,8-cineole, were added to the concentration as shown in Table 2 in the aqueous solution of 4 w/v % acetic acid to prepare test products D1 to D9. An aqueous solution containing acetic acid but not supplemented with the components to be analyzed was used as a control sample.

### (2) Sensory Evaluation Test

The test products prepared in (1) above were subjected to the sensory evaluation of the acetic acid odor in the same manner as in Test Example 1. The results are shown in Table 2.

TABLE 2

| | | | Concentration of | Evaluation of |
|---|---|---|---|---|
| Test | | Acetic acid | component | acetic acid odor |
| product | Component | (w/v %) | (ppb) | (point) |
| Control | Not added | 4 | 0 | 5.0 |
| D1 | 2-Octenal | 4 | 50 | 2.2 |
| | (+) Rose oxide | | 50 | |
| D2 | 2-Octenal | 4 | 50 | 2.7 |
| | 1.8-Cineole | | 50 | |
| D3 | (+) Rose oxide | 4 | 50 | 2.8 |
| | 1,8-Cineole | | 50 | |
| D4 | 2-Octenal | 4 | 0.003 | 3.2 |
| | (+) Rose oxide | | 0.003 | |
| | 1.8-Cineole | | 0.003 | |
| D5 | 2-Octenal | 4 | 0.03 | 3.2 |
| | (+) Rose oxide | | 0.03 | |
| | 1,8-Cineole | | 0.03 | |
| D6 | 2-Octenal | 4 | 0.3 | 2.7 |
| | (+) Rose oxide | | 0.3 | |
| | 1,8-Cineole | | 0.3 | |
| D7 | 2-Octenal | 4 | 3.0 | 2.7 |
| | (+) Rose oxide | | 3.0 | |
| | 1,8-Cineole | | 3.0 | |
| D8 | 2-Octenal | 4 | 33 | 2.0 |
| | (+) Rose oxide | | 33 | |
| | 1.8-Cineole | | 33 | |
| D9 | 2-Octenal | 4 | 333 | 1.7 |
| | (+) Rose oxide | | 333 | |
| | 1.8-Cineole | | 333 | |

As shown in Table 2, two or more of 2-octenal, (+)-rose oxide, and 1,8-cineole were found to suppress the acetic acid odor in combination. With the use of two or more of the components in combination, the effects of masking the acetic acid odor were found to be improved.

### Test Example 3

### (1) Preparation of Test Solution

In the same manner as in Test Example 1, one or three of the diluted solutions of the components to be evaluated: 2-octenal, (+)-rose oxide, and 1,8-cineole, was or were added to the concentration as shown in Table 3 in the aqueous solution of 4 w/v % acetic acid to prepare test products A7, B7, C7, and D10. An aqueous solution containing acetic acid but not supplemented with the components to be analyzed was used as a control sample.

### (2) Sensory Evaluation Test

On the assumption that samples were acetic acid-containing cleaner compositions, suppression of the acetic acid odor was evaluated in the manner described below. The test product or a control sample was introduced into a 100-ml spray bottle and sprayed into a 200-ml glass beaker. The selected 10 professional panelists for sensory evaluation smelled the samples to evaluate the acetic acid odor. Evaluation was performed in accordance with the criteria of Test Example 1. The results are shown in Table 3.

TABLE 3

| | | | Concentration of | Evaluation of |
|---|---|---|---|---|
| Test | | Acetic acid | component | acetic acid odor |
| product | Componen | (w/v %) | (ppb) | (point) |
| Control | Not added | 4 | 0 | 5.0 |
| A7 | 2-Octenal | 4 | 100 | 2.7 |
| B7 | (+) Rose oxide | 4 | 100 | 3.3 |
| C7 | 1,8-Cineole | 4 | 100 | 2.7 |
| D10 | 2-Octenal | 4 | 33 | 2.0 |
| | (+) Rose oxide | | 33 | |
| | 1,8-Cineole | | 33 | |

As shown in Table 3, the acetic acid odor of the sprayed acetic acid solution was found to be suppressed by including one or more components selected from among 2-octenal, (+)-rose oxide, and 1,8-cineole.

Polyoxyethylene alkyl ether, which is not approved for use in food, was added in an amount of 1% to the test products A7, B7, C7, and D10 prepared in Test Example 3 to prepare cleaners, which are non-food or beverage products. In the same manner as in Test Example 3, suppression of the acetic acid odor was evaluated. The results similar to those as shown in Table 3 were attained, although the results were not shown.

### Test Example 4

### (1) Preparation of Test Solution

In the same manner as in Test Example 1, one or more of the diluted solutions of the components to be evaluated: 2-octenal, (+)-rose oxide, and 1,8-cineole, were added to the concentration as shown in Table 4 to prepare test products E11 to E16. In the same manner as in Test Example 1, an aqueous solution of 4 w/v % acetic acid was used as a control sample.

### (2) Sensory Evaluation Test

The test products prepared in (1) above were subjected to the sensory evaluation of the acetic acid odor in the same manner as in Test Example 1. The results are shown in Table 4.

TABLE 4

| | Acetic | (A) 2-Octenal | | (B) (+) Rose oxide | | (C) 1,8-Cineole | | | | | Evaluation of | |
|---|---|---|---|---|---|---|---|---|---|---|---|---|
| Test | acid | | Ratio to | | Ratio to | | Ratio to | | | | acetic acid odor | |
| product | (w/v %) | (ppb) | acetic acid | (ppb) | acetic acid | (ppb) | acetic acid | (B)/(A) | (C)/(A) | (C)/(B) | (point) | Remarks |
| Control | 4 | 0 | — | 0 | — | 0 | — | — | — | — | 5.0 | |
| E11 | 0.02 | 10 | 500 | 10 | 500 | 10 | 500 | 1 | 1 | 1 | 1.0 | Odor other than |
| | | | | | | | | | | | | acetic acid |
| E12 | 0.05 | 10 | 200 | 5 | 100 | 5 | 100 | 0.5 | 0.5 | 1 | 1.2 | |
| E13 | 0.1 | 10 | 100 | 5 | 50 | 0 | — | 0.5 | — | — | 1.3 | |
| E14 | 0.5 | 10 | 20 | 0 | 0 | 5 | 10 | — | 0.5 | — | 1.7 | |
| E15 | 1 | 0 | 0 | 5 | 5 | 10 | 10 | — | — | 2 | 1.7 | |
| E16 | 10 | 0 | 0 | 10 | 1 | 5 | 0.5 | — | — | 0.5 | 3.0 | |

As shown in Table 4, inclusion of one or more components selected from among 2-octenal, (+)-rose oxide, and 1,8-cineole was found to suppress the acetic acid odor at acetic acid concentration of 1 w/v % or less.

### Test Example 5

### (1) Preparation of Test Solution

In the same manner as in Test Example 1, aqueous solutions containing acetic acid at the concentration shown in Table 5 were prepared, and the diluted solutions of the components to be evaluated: 2-octenal, (+)-rose oxide, and 1,8-cineole, were added to the concentration as shown in Table 5 to prepare test products K11 to K16, L21 to L25, M31 to M33, and N41 to N43. An aqueous solution containing acetic acid but not supplemented with the components to be analyzed was used as a control sample.

### (2) Sensory Evaluation Test

The test products prepared in (1) above were subjected to the sensory evaluation of the acetic acid odor in the same manner as in Test Example 1. The results are shown in Table 5.

TABLE 5

| | Acetic | 2-Octenal | | (+) Rose oxide | | 1,8-Cineole | | Evaluation of | |
|---|---|---|---|---|---|---|---|---|---|
| Test | acid | | Ratio to | | Ratio to | | Ratio to | acetic acid odor | |
| product | (w/v %) | (ppb) | acetic acid | (ppb) | acetic acid | (ppb) | acetic acid | (point) | Remarks |
| Control | 10 | 0 | — | 0 | — | 0 | — | 5.0 | |
| K11 | 10 | 10 | 1.0 | 0 | — | 0 | — | 4.0 | |
| K12 | 10 | 100 | 10.0 | 0 | — | 0 | — | 2.7 | |
| K13 | 10 | 0 | — | 10 | 1.0 | 0 | — | 3.0 | |
| K14 | 10 | 0 | — | 100 | 10.0 | 0 | — | 2.7 | |
| K15 | 10 | 0 | — | 0 | — | 10 | 1.0 | 2.7 | |
| K16 | 10 | 0 | — | 0 | — | 100 | 10.0 | 2.5 | |
| Control | 20 | 0 | — | 0 | — | 0 | — | 5.0 | |
| L21 | 20 | 100 | 5.0 | 0 | — | 0 | — | 2.8 | |
| L22 | 20 | 0 | — | 10 | 0.5 | 0 | — | 4.2 | |
| L23 | 20 | 0 | — | 100 | 5.0 | 0 | — | 3.2 | |
| L24 | 20 | 0 | — | 0 | — | 10 | 0.5 | 4.0 | |
| L25 | 20 | 0 | — | 0 | — | 100 | 5.0 | 3.0 | |
| Control | 30 | 0 | — | 0 | — | 0 | — | 5.0 | Irritation to nose |
| M31 | 30 | 1000 | 33.3 | 0 | — | 0 | — | 2.3 | Irritation to nose, |
| | | | | | | | | | but acetic acid odor |
| | | | | | | | | | is weak |
| M32 | 30 | 0 | — | 1000 | 33.3 | 0 | — | 3.3 | Irritation to nose, |
| | | | | | | | | | but acetic acid odor |
| | | | | | | | | | is weak |
| M33 | 30 | 0 | — | 0 | — | 1000 | 33.3 | 3.3 | |
| Control | 40 | 0 | — | 0 | — | 0 | — | 5.0 | Irritation to nose |
| N41 | 40 | 1000 | 25.0 | 0 | — | 0 | — | 2.8 | Irritation to nose, |
| | | | | | | | | | but acetic acid odor |
| | | | | | | | | | is weak |
| N42 | 40 | 0 | — | 1000 | 25.0 | 0 | — | 3.5 | Irritation to nose |
| N43 | 40 | 0 | — | 0 | — | 1000 | 25.0 | 3.7 | Irritation to nose |

As shown in Table 5, inclusion of one or more components selected from among 2-octenal, (+)-rose oxide, and 1,8-cineole was found to suppress the acetic acid odor even if the acetic acid concentration was 10 w/v % or higher. While irritation to the nose was sensed at the acetic acid concentration of 30 w/v % or higher, inclusion of one or more components selected from among 2-octenal, (+)-rose oxide, and 1,8-cineole was found to suppress the acetic acid odor.

### Test Example 6

### (1) Preparation of Herbal Extract

Dry elderflower (Herbaria) (2% by mass) was introduced into a tea bag, the tea bag was introduced into 98% by mass of water (pH 7.0) adjusted to 90° C., the resultant was held at 90° C. for 3 minutes and then cooled to room temperature (25° C.) in a water bath, and the teabag was removed therefrom to obtain 2% by mass of an elderflower extract (Extract a). Also, 10% by mass of dry elderflower was used to obtain 10% by mass of an elderflower extract (Extract b). As the cardamom extract, CARDAMOM C1536 1% SNO ETOH (Sensient Flavors) was used (Extract c).

### (2) GC/MS Analysis of Extract

The content of (A) 2-octenal, that of (B) (+)-rose oxide, and that of (C) 1,8-cineole in the extract prepared in (1) were quantified by the stir bar sorptive extraction (SBSE) method using a gas chromatography mass spectrometer (GC/MS).

Standard preparations of components of known contents were diluted with 99.5% ethanol to adjust the concentration to 1000 ppm, the resultants were further diluted with ultrapure water to adjust the concentration to adequate levels (i.e., diluted standard preparations), and the diluted standard preparations and samples were then analyzed. The diluted standard preparations (10 ml) and the samples (10 ml) were each stirred with two stir bars (Twister, GERSTEL) for 2 hours, so as to adsorb the components to the polydimethylsiloxane (PDMS) layers of the stir bars, and the stir bars were then subjected to analysis. The target components in the samples were quantified by comparing the results of the integrated peak areas of the amounts of confirmation ions detected in the diluted standard preparations and those of the samples at the retention times, which were considered to be of the target components in comparison with the retention times of the standard preparations, by the analysis based on the mass spectral patterns obtained using a mass spectrometer. Regarding 2-octenal, m/z=41, 55, 70, and 83 were detected at retention times around 20 to 23 minutes; regarding (+)-rose oxide, m/z=69 and 139 were detected at retention times around 16 to 22 minutes; and regarding 1,8-cineole, m/z=43, 81, and 154 were detected at retention times around 12 to 17 minutes. At the retention time in which the above ions were significally detected in common, the results of integrating peak area at m/z=41 for 2-octenal, peak area at m/z=139 for (+)-rose oxide, and peak area at m/z=43 for 1,8-cineole were measured.

### <Gas Chromatography Mass Spectrometer (GC/MS) Conditions>

Apparatuses: 7890B (GC) and 5977B (MS) (Agilent), MultiPurpose Sampler (auto-sampler) (Gester)
Adsorption resin: TENAX
Incubation temperature: 80° C.
Amount of nitrogen gas purge: 60 ml
Flow rate of nitrogen gas purge: 10 ml/min
TDU: [30° C.]-[720° C./min]-[240° C. (3 min)]
CIS: [10° C.]-[12° C./sec]-[240° C.]

As a capillary column, DB-WAX (length: 30 m; inner diameter: 250 μm; membrane thickness: 0.25 μm, for LTM, Agilent) was used as one-dimensional column. As carrier gas, helium was used.

The Extract (a) prepared in (1) was subjected to GC/MS. As a result, the concentration of (A) 2-octenal was 0.5 ppb, that of (B) (+)-rose oxide was 15.8 ppb, and that of (C) 1,8-cineole was 19.1 ppb. The Extract (b) was subjected to GC/MS. As a result, the concentration of (A) 2-octenal was 2.52 ppb, that of (B) (+)-rose oxide was 46.5 ppb, and that of (C) 1,8-cineole was 95.4 ppb. The cardamom extract of (1) was subjected to GC/MS. As a result, the concentration of (C) 1,8-cineole was 229 ppm.

### (3) Haze Value

The temperature of the Extract (a), that of the Extract (b), and that of the Extract (c) prepared in (1) were adjusted to room temperature (25° C.) in a water bath, and the haze values thereof were measured with reference to ISO 14782:1999. The haze value of the Extract (a) was 0.6%, that of the Extract (b) was 1.0%, and that of the Extract (c) was 0.3%.

### (4) Preparation of Test Solution

In the same manner as in Test Example 1, the extract of (1) was added to the concentration as shown in Table 6 in the aqueous solution of 4 w/v % acetic acid to prepare test products G1 to G4. An aqueous solution containing acetic acid but not supplemented with the extract was used as a control sample.

### (5) Sensory Evaluation Test

The test products prepared in (4) were subjected to the sensory evaluation of the acetic acid odor in the same manner as in Test Example 1. The results are shown in Table 6.

TABLE 6

| | | | | (A) 2-Octenal | | (B) (+) Rose oxide | | (C) 1,8-Cineole | | | | | Evaluation |
|---|---|---|---|---|---|---|---|---|---|---|---|---|---|
| | | Acetic | Amount of | | Ratio to | | Ratio to | | Ratio to | | | | of acetic |
| Test | | acid | extract | | acetic | | acetic | | acetic | | | | acid odor |
| product | Extract | (w/v %) | (%) | (ppb) | acid | (ppb) | acid | (ppb) | acid | (B)/(A) | (C)/(A) | (C)/(B) | (point) |
| G1 | Control | 4 | 0 | 0.0 | — | 0.0 | — | 0.0 | — | — | — | — | 5.0 |
| G2 | Cardamom extract | 4 | 0.002 | 0.0 | — | 0.0 | — | 457 | 114 | — | — | — | 2.0 |
| | (Extract c) | | | | | | | | | | | | |
| G3 | Elderflower extract | 4 | 10 | 0.05 | 0.013 | 1.6 | 0.4 | 1.9 | 0.5 | 32.0 | 38.0 | 1.2 | 1.8 |
| | (Extract a) | | | | | | | | | | | | |
| G4 | Elderflower extract | 4 | 1 | 0.25 | 0.06 | 4.7 | 1.2 | 9.5 | 2.4 | 19.0 | 38.0 | 2.0 | 1.8 |
| | (Extract b) | | | | | | | | | | | | |

As shown in Table 6, use of an extract of plant material containing one or more components selected from among 2-octenal, (+)-rose oxide, and 1,8-cineole was found to suppress the acetic acid odor.

### Test Example 7

### (1) Preparation of Herbal Tea

As shown in Table 7, water adjusted to 90° C. was added to herbal tea leaves (Earl Grey: Lipton Earl Grey (Morinaga Milk Industry Co. Ltd.); chamomile: Lipton Chamomile Herb (Morinaga Milk Industry Co. Ltd.); elderflower: Organic Elderflower Teabag (Tree of Life); rosehip: Nitto Aroma House Beauty Rosehip Tea Blend (Mitsui Norin Co., Ltd.)), the teabags were held for 3 minutes, the temperature thereof was cooled to room temperature (25° C.) in a water bath, and the teabags were removed to prepare herbal tea samples.

### (2) GC/MS

The content of (A) 2-octenal, that of (B) (+)-rose oxide, and that of (C) 1,8-cineole in the herbal tea sample prepared in (1) were quantified by the stir bar sorptive extraction (SBSE) method using the gas chromatography mass spectrometer (GC/MS).

Standard preparations of components of known contents were diluted with 99.5% ethanol to adjust the concentration to 1000 ppm, the resultants were further diluted with ultrapure water to adjust the concentration to adequate levels (i.e., diluted standard preparations), and the diluted standard preparations and samples were then analyzed. The diluted standard preparations (10 ml) and the samples (10 ml) were each stirred with two stir bars (Twister, GERSTEL) for 2 hours, so as to adsorb the components to the polydimethylsiloxane (PDMS) layers of the stir bars, and the stir bars were then subjected to analysis. The target components in the samples were quantified by comparing the results of the integrated peak areas of the amounts of confirmation ions detected in the diluted standard preparations and those of the samples at the retention times, which were considered to be of the target components in comparison with the retention times of the standard preparations, by the analysis based on the mass spectral patterns obtained using a mass spectrometer. Regarding 2-octenal, m/z=41, 55, 70, and 83 were detected at retention times around 20 to 23 minutes; regarding (+)-rose oxide, m/z=69 and 139 were detected at retention times around 16 to 22 minutes; and regarding 1,8-cineole, m/z=43, 81, and 154 were detected at retention times around 12 to 17 minutes. At the retention time in which the above ions were significally detected in common, the results of integrating peak area at m/z=41 for 2-octenal, peak area at m/z=139 for (+)-rose oxide, and peak area at m/z=43 for 1,8-cineole were measured.

### <Gas Chromatography Mass Spectrometer (GC/MS) Conditions>

Apparatuses: 7890B (GC) and 5977B (MS) (Agilent), MultiPurpose Sampler (auto-sampler) (Gester)
Adsorption resin: TENAX
Incubation temperature: 80° C.
Amount of nitrogen gas purge: 60 ml
Flow rate of nitrogen gas purge: 10 ml/min
TDU: [30° C.]-[720° C./min]-[240° C. (3 min)]
CIS: [10° C.]-[12° C./sec]-[240° C.]

As a capillary column, DB-WAX (length: 30 m; inner diameter: 250 μm; membrane thickness: 0.25 μm, for LTM, Agilent) was used as one-dimensional column. As carrier gas, helium was used.

The herbal tea samples prepared in (1) were subjected to GC/MS. In the chamomile tea, the concentration of (C) 1,8-cineole was 0.5 ppb. In the elderflower tea, the concentration of (A) 2-octenal was 0.005 ppb, that of (B) (+)-rose oxide was 0.16 ppb, and that of (C) 1,8-cineole was 0.19 ppb. In the rosehip tea, the concentration of (B) (+)-rose oxide was 0.56 ppb. None of the components (A) to (C) was detected in the Earl Grey tea.

### (3) Preparation of Test Solution

In the same manner as in Test Example 1, an aqueous solution of 0.5 w/v % acetic acid was mixed with each of the herbal tea samples of (1) as shown in Table 7 to prepare test products H1 to H5.

### (4) Sensory Evaluation Test

The test products prepared in (3) were subjected to the sensory evaluation of the acetic acid odor in the same manner as in Test Example 1. The results are shown in Table 7.

TABLR 7

| | | | | | | | | | | | | | Evaluation |
|---|---|---|---|---|---|---|---|---|---|---|---|---|---|
| | | | Acetic | (A) 2-Octenal | | (B) (+) Rose oxide | | (C) 1,8-Cineole | | | | | of acetic |
| Test | Tea leaves | | acid | | Ratio to | | Ratio to | | Ratio to | | | | acid odor |
| product | Type | (w/v %) | (w/v %) | (ppb) | acetic acid | (ppb) | acetic acid | (ppb) | acetic acid | (B)/(A) | (C)/(A) | (C)/(B) | (point) |
| H1 | Earl Grey | 0.014 | 0.5 | 0.00 | — | 0.00 | — | 0.00 | — | — | — | — | 5.0 |
| H2 | Chamomile | 0.014 | 0.5 | 0.00 | — | 0.00 | — | 0.50 | 1.00 | — | — | — | 2.5 |
| H3 | Chamomile | 0.021 | 0.5 | 0.00 | — | 0.00 | — | 0.76 | 1.52 | — | — | — | 2.5 |
| H4 | Elderflower | 0.02 | 0.5 | 0.005 | 0.01 | 0.16 | 0.32 | 0.19 | 0.38 | 32 | 38 | 1.2 | 2.5 |
| H5 | Rosehip | 0.040 | 0.5 | 0.00 | — | 0.56 | 1.12 | 0.00 | — | — | — | — | 2.0 |

As shown in Table 7, the acetic acid odor was found to be suppressed if an herbal tea containing one or more components selected from among 2-octenal, (+)-rose oxide, and 1,8-cineole was mixed with acetic acid.

In Tables 1 to 7, pH levels of the test products were less than 3.0, and the concentration of undissociated acetic acid (AH) relative to the concentration of acetic acid was 98.2 w/v % or higher.

One or more embodiments of the present invention can be used in the field of production of an acetic acid-containing composition, such as a food or beverage product or a cleaner containing acetic acid.

All publications, patents, and patent applications cited herein are incorporated herein by reference in their entirety.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. An acetic acid-containing composition, comprising:
0.02 w/v % or more of acetic acid; and
one or more components selected from the group consisting of (A) 2-octenal, (B) (+)-rose oxide, and (C) 1,8-cineole.

2. An acetic acid-containing composition, comprising:
4 w/v % or more of acetic acid;
a surfactant; and
one or more components selected from the group consisting of (A) 2-octenal, (B) (+)-rose oxide, and (C) 1,8-cineole,
wherein a concentration of undissociated acetic acid (AH) relative to the concentration of acetic acid in the acetic acid-containing composition is 98.2 w/v % or higher.

3. The acetic acid-containing composition according to claim 2, wherein the concentration of undissociated acetic acid (AH) in the acetic acid-containing composition is 10 w/v % to 40 w/v %.

4. The acetic acid-containing composition according to claim 2, wherein a content of (A) 2-octenal in the acetic acid-containing composition is 0.001 ppb or more and 1000 ppb or less.

5. The acetic acid-containing composition according to claim 2, wherein a content of (B) (+)-rose oxide in the acetic acid-containing composition is 0.001 ppb or more and 1000 ppb or less.

6. The acetic acid-containing composition according to claim 2, wherein a content of (C) 1,8-cineole in the acetic acid-containing composition is 0.001 ppb or more and 1000 ppb or less.

7. The acetic acid-containing composition according to claim 2, wherein a ratio of a content of (A) 2-octenal to a content of acetic acid (2-octenal (ppb)/acetic acid (w/v %)) is 0.0005 to 500.

8. The acetic acid-containing composition according to claim 2, wherein a ratio of a content of (B) (+)-rose oxide to a content of acetic acid (rose oxide (ppb)/acetic acid (w/v %)) is 0.0005 to 500.

9. The acetic acid-containing composition according to claim 2, wherein a ratio of a content of (C) 1,8-cineole to a content of acetic acid (1,8-cineole (ppb)/acetic acid (w/v %)) is 0.0005 to 500.

10. The acetic acid-containing composition according to claim 2, wherein a content of (B) (+)-rose oxide relative to 1 part by mass of (A) 2-octenal is 0.00001 parts by mass to 100000 parts by mass.

11. The acetic acid-containing composition according to claim 2, wherein a content of (C) 1,8-cineole relative to 1 part by mass of (A) 2-octenal is 0.00001 parts by mass to 100000 parts by mass.

12. The acetic acid-containing composition according to claim 2, wherein a content of (C) 1,8-cineole relative to 1 part by mass of (B) (+)-rose oxide is 0.00001 parts by mass to 100000 parts by mass.

13. The acetic acid-containing composition according to claim 2, wherein the one or more components selected from the group consisting of (A) 2-octenal, (B) (+)-rose oxide, and (C) 1,8-cineole are derived from an extract of plant material.

14. The acetic acid-containing composition according to claim 13, wherein the plant material is at least one member selected from the group consisting of grape, apricot, melon, water melon, mango, kiwi fruit, rosemary, olive, elderflower, rose, geranium, lemongrass, yellow batai, eucalyptus, peppermint, fenugreek, chamomile, cardamom, cumin, apple mint, laurel, cinnamon, rosehip, thyme, and nutmeg.

15. A method for producing the acetic acid-containing composition according to claim 2, comprising the following steps (i) and (ii):
(i) a step of preparing an acetic acid-containing composition containing acetic acid at 0.02 w/v % or higher; and
(ii) a step of adding the one or more components selected from the group consisting of (A) 2-octenal, (B) (+)-rose oxide, and (C) 1,8-cineole to the acetic acid-containing composition obtained in the step (i).

16. The method for production according to claim 15, wherein, in the step (i), a concentration of undissociated acetic acid (AH) in the acetic acid-containing composition is 10 w/v % to 40 w/v %.

17. The method for production according to claim 15, wherein the step (ii) comprises adding (A) 2-octenal to the acetic acid-containing composition, so as to adjust a concentration of the (A) 2-octenal in the acetic acid-containing composition to 0.001 ppb or more and 1000 ppb or less.

18. The method for production according to claim 15, wherein the step (ii) comprises adding (B) (+)-rose oxide to the acetic acid-containing composition, so as to adjust a concentration of the (B) (+)-rose oxide in the acetic acid-containing composition to 0.001 ppb or more and 1000 ppb or less.

19. The method for production according to claim 15, wherein the step (ii) comprises adding (C) 1,8-cineole to the acetic acid-containing composition, so as to adjust a concentration of the (C) 1,8-cineole in the acetic acid-containing composition to 0.001 ppb or more and 1000 ppb or less.

20. The method for production according to claim 15, wherein the step (ii) comprises a step of extracting a plant material.

21. The method for production according to claim 15, wherein a content of dietary fiber in the acetic acid-containing composition in the step (ii) is 10% by mass or less than a content of dietary fiber in the acetic acid-containing composition in the step (i).

22. The method for production according to claim 15, wherein the step (i) or (ii) comprises adding a surfactant to the acetic acid-containing composition.
